(19) United States
(12) Patent Application Publication
(10) Pub. No.: US 2024/0397128 A1
(43) Pub. Date: Nov. 28, 2024

(54) METHOD, APPARATUS AND COMPUTER PROGRAM PRODUCT FOR IMPLEMENTING MECHANISMS FOR CARRIAGE OF RENDERABLE TEXT

(71) Applicant: Nokia Technologies Oy, Espoo (FI)

(72) Inventors: Kashyap KAMMACHI SREEDHAR, Tampere (FI); Emre Baris AKSU, Tampere (FI); Lauri Aleksi ILOLA, Tampere (FI); Igor Danilo Diego CURCIO, Vimercate (IT)

(21) Appl. No.: 18/695,611

(22) PCT Filed: Oct. 4, 2022
(86) PCT No.: PCT/IB2022/059471

§ 371 Date: Mar. 26, 2024

Related U.S. Application Data
(60) Provisional application No. 63/262,075, filed on Oct. 4, 2021.
(60) Provisional application No. 63/265,953, filed on Dec. 23, 2021.

(51) Int. Cl. H04N 21/235; G06F 40/109; H04N 21/488; H04N 21/84

(52) U.S. Cl. CPC H04N 21/2353; G06F 40/109; H04N 21/4884; H04N 21/84

(57) ABSTRACT

Various embodiments provide a method, an apparatus, and a computer program product. An example apparatus includes at least one processor; and at least one non-transitory memory comprising computer program code; wherein the at least one memory and the computer program code are configured to, with the at least one processor, cause the apparatus at least to perform: define a text item, wherein decoding of the text item results in a textual content or text data; and associate the text item with a media item.

### TECHNICAL FIELD

The examples and non-limiting embodiments relate generally to multimedia transport, and more particularly, to method, apparatus, and computer program product for implementing mechanisms for carriage of renderable text.

### BACKGROUND

It is known to perform coding and decoding.

### SUMMARY

An example method includes: defining a text item, wherein decoding of the text item results in a textual content or text data; and associating the text item with a media item.

The example method may further include, wherein defining the text item comprises defining at least one of a renderable item or a renderable item property, wherein the renderable item or a renderable item property comprises rendering information required to render a renderable text on a canvas, a background media item, or an overlay of the media item.

The example method may further include, wherein the rendering information comprises one or more of following parameters: a language of the renderable text; a location of the renderable text on a canvas or a background media; a width and a height of the renderable text; or a direction of the renderable text.

The example method may further include, wherein the location is signaled by using a horizontal and a vertical offset from a top-left corner of the canvas or the background media.

The example method may further include, wherein the direction of the renderable text comprises left to right or right to left.

The example method may further include defining a mime type item for the renderable text, and wherein the media item comprising value of ‘mime’ in an item type comprises a mime type item.

The example method may further include, wherein data in the mime type item comprises the renderable text.

The example method may further include encoding the renderable text, and wherein the encoding is defined by using a content encoding parameter comprised in an item information entry of an item formation box.

The example method may further include decoding the data prior to interpreting the data as the mime type item when the renderable text is encoded with an algorithm defined for content-encoding of a version of HTTP or a data transfer protocol.

The example method may further include, wherein no content encoding is applied to the renderable text, when the content encoding parameter comprises an empty string.

The example method may further include, wherein the renderable text is defined by using a text item data structure comprising one or more of the following: a reference width field for specifying a width of a reference space on which the renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising renderable text.

The example method may further include, wherein the rendering information for the mime type item with renderable text is defined as part of a descriptive item property or the transformative item property of the mime type item associated with the renderable text.

The example method may further include providing rendering layout information of the associated mime type item with the renderable text by using a text layout property.

The example method may further include, wherein the text layout property is defined by using a data structure comprising one or more of the following: a reference width field for specifying a width of a reference space on which the renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising renderable text.

An example computer readable medium includes program instructions for causing an apparatus to perform at least the following: define a text item, wherein decoding of the text item results in a textual content or text data; and associate the text item with a media item.

The example computer readable medium may further include, wherein the apparatus is further caused to perform the methods as claimed in any of the previous paragraphs.

The example computer readable medium may further include, wherein the computer readable medium comprises a non-transitory computer readable medium.

Another example method includes receiving a bitstream comprising a media item, wherein the media item is associated with a text item; accessing the text item; and rendering content of the text item.

The example method may further include, wherein the text item comprises at least one of a renderable item or a renderable item property, wherein the renderable item or a renderable item property comprises rendering information required to render a renderable text on a canvas, a background media item, or an overlay of the media item.

The example method may further include, wherein the rendering information comprises one or more of following parameters: a language of the renderable text; a location of the renderable text on a canvas or a background media; a width and a height of the renderable text; or a direction of the renderable text.

The example method may further include, wherein the location is signaled by using a horizontal and a vertical offset from a top-left corner of the canvas or the background media.

The example method may further include, wherein the direction of the renderable text comprises left to right or right to left.

The example method may further include, wherein the renderable text is defined by using a text item data structure comprising one or more of the following: a reference width field for specifying a width of a reference space on which the renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising renderable text.

The example method may further include deriving a reconstructed renderable text of the text item or a mime type item, wherein the data in the mime type item comprises the renderable text, and wherein deriving the reconstructed renderable text includes: decoding the renderable text and providing the reconstructed renderable text as an output of the decoding process when the text item or the mime type item comprises the renderable text; and applying operation of a derived text item or a derived mime type item to an input of the derived text item or the derived mime type item when the text item or the mime type item is the derived text item or the derived mime type item.

The example method may further include deriving an output renderable text of the text item or the mime type item from the reconstructed renderable text of the text item or the mime type item, wherein the output renderable text is identical or substantially identical to the reconstructed renderable text when the text item or the mime type item has no transformative item properties, and wherein, when the text item or the mime type item comprises transformative item properties, deriving the output renderable text includes: forming a sequence of transformative item properties from essential transformative item properties of the text item or the mime type item and non-essential transformative item properties of the text item or the mime type item; and applying the sequence of transformative item properties, in the order of appearance of the sequence of transformative item properties for the text item or the mime type item, to the reconstructed renderable text to obtain the output renderable text.

Another example computer readable medium includes program instructions for causing an apparatus to perform at least the following: define a text item, wherein decoding of the text item results in a textual content or text data; and associate the text item with a media item.

The example computer readable medium may further include, wherein the apparatus is further caused to perform the methods as claimed in any of the previous paragraphs.

The example computer readable medium may further include, wherein the computer readable medium comprises a non-transitory computer readable medium.

Yet another example method includes: defining a data structure including one or more of the following: a reference width field for specifying a width of a reference space on which a renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising the renderable text; and using the data structure to define the renderable text.

Yet another computer readable medium includes program instructions for causing an apparatus to perform at least the following: define a data structure comprising one or more of the following: a reference width field for specifying a width of a reference space on which a renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising the renderable text; and use the data structure to define the renderable text.

The example computer readable medium may further include, wherein the computer readable medium comprises a non-transitory computer readable medium.

An apparatus includes at least one processor; and at least one non-transitory memory comprising computer program code; wherein the at least one memory and the computer program code are configured to, with the at least one processor, cause the apparatus at least to: define a text item, wherein decoding of the text item results in a textual content or text data; and associate the text item with a media item.

The example apparatus may further include, wherein to define the text item, the apparatus is caused to define at least one of a renderable item or a renderable item property, wherein the renderable item or a renderable item property comprises rendering information required to render a renderable text on a canvas, a background media item, or an overlay of the media item.

The example apparatus may further include, wherein the rendering information comprises one or more of following parameters: a language of the renderable text; a location of the renderable text on a canvas or a background media; a width and a height of the renderable text; or a direction of the renderable text.

The example apparatus may further include, wherein the location is signaled by using a horizontal and a vertical offset from a top-left corner of the canvas or the background media.

The example apparatus may further include, wherein the direction of the renderable text comprises left to right or right to left.

The example apparatus may further include, wherein the apparatus is further caused to define a mime type item for the renderable text, and wherein the media item comprising value of ‘mime’ in an item type comprises a mime type item.

The example apparatus may further include, wherein data in the mime type item comprises the renderable text.

The example apparatus may further include, wherein the apparatus is further caused to encode the renderable text, and wherein the encoding is defined by using a content encoding parameter comprised in an item information entry of an item formation box.

The example apparatus may further include, wherein the apparatus is further caused to decode the data prior to interpreting the data as the mime type item when the renderable text is encoded with an algorithm defined for content-encoding of a version of HTTP or a data transfer protocol.

The example apparatus may further include, wherein no content encoding is applied to the renderable text, when the content encoding parameter comprises an empty string.

The example apparatus may further include, wherein the renderable text is defined by using a text item data structure comprising one or more of the following: a reference width field for specifying a width of a reference space on which the renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising renderable text.

The example apparatus may further include, wherein the rendering information for the mime type item with renderable text is defined as part of a descriptive item property or the transformative item property of the mime type item associated with the renderable text.

The example apparatus may further include, wherein the apparatus is further caused to provide rendering layout information of the associated mime type item with the renderable text by using a text layout property.

The example apparatus may further include, wherein the text layout property is defined by using a data structure comprising one or more of the following: a reference width field for specifying a width of a reference space on which the renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising renderable text.

Another example apparatus includes at least one processor; and at least one non-transitory memory comprising computer program code; wherein the at least one memory and the computer program code are configured to, with the at least one processor, cause the apparatus at least to: receive a bitstream comprising a media item, wherein the media item is associated with a text item; access the text item; and render content of the text item.

The example apparatus may further include, wherein the text item comprises at least one of a renderable item or a renderable item property, wherein the renderable item or a renderable item property comprises rendering information required to render a renderable text on a canvas, a background media item, or an overlay of the media item.

The example apparatus may further include, wherein the rendering information comprises one or more of following parameters: a language of the renderable text; a location of the renderable text on a canvas or a background media; a width and a height of the renderable text; or a direction of the renderable text.

The example apparatus may further include, wherein the location is signaled by using a horizontal and a vertical offset from a top-left corner of the canvas or the background media.

The example apparatus may further include, wherein the direction of the renderable text comprises left to right or right to left.

The example apparatus may further include, wherein the renderable text is defined by using a text item data structure comprising one or more of the following: a reference width field for specifying a width of a reference space on which the renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising renderable text.

The example apparatus may further include, wherein the apparatus is further caused to derive a reconstructed renderable text of the text item or a mime type item, wherein the data in the mime type item comprises the renderable text, and wherein to derive the reconstructed renderable text, the apparatus is further caused to: decode the renderable text and providing the reconstructed renderable text as an output of the decoding process when the text item or the mime type item comprises the renderable text; and apply operation of a derived text item or a derived mime type item to an input of the derived text item or the derived mime type item when the text item or the mime type item is the derived text item or the derived mime type item.

The example apparatus may further include, wherein the apparatus is further caused to derive an output renderable text of the text item or the mime type item from the reconstructed renderable text of the text item or the mime type item, wherein the output renderable text is identical or substantially identical to the reconstructed renderable text when the text item or the mime type item has no transformative item properties, and wherein, when the text item or the mime type item comprises transformative item properties, wherein the to derive the output renderable text, the apparatus is further caused to: form a sequence of transformative item properties from essential transformative item properties of the text item or the mime type item and non-essential transformative item properties of the text item or the mime type item; and apply the sequence of transformative item properties, in the order of appearance of the sequence of transformative item properties for the text item or the mime type item, to the reconstructed renderable text to obtain the output renderable text.

Yet another example apparatus includes at least one processor; and at least one non-transitory memory comprising computer program code; wherein the at least one memory and the computer program code are configured to, with the at least one processor, cause the apparatus at least to: define a data structure comprising one or more of the following: a reference width field for specifying a width of a reference space on which a renderable text data is placed; a reference height field for specifying a height of the reference space on which the renderable text data is placed; a language field comprising language tag string representing a language of the renderable text; x and y fields for specifying a top, left corner of the renderable text relatively to the reference space, and wherein a value x=0 and y=0 represents a position of a top-left pixel in the reference space; width and height fields for the renderable text describes a size of a rendering area in the reference area; a flag for indicting at least one of a length of the fields x, y, the width, the height, the reference height, or the reference width for the renderable text; a direction field for indicating a direction in which the content of the text item needs to be rendered; or a text field comprising a character string comprising the renderable text; and use the data structure to define the renderable text.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block chart of an encoder on a general level.

FIG. 5 is a block diagram showing the interface between an encoder and a decoder in accordance with the examples described herein.

FIG. 6 illustrates a system configured to support streaming of media data from a source to a client device;

FIG. 7 is a block diagram of an apparatus that may be configured in accordance with an example embodiment.

FIG. 8 is an example apparatus, which may be implemented in hardware, configured to implement mechanisms for carriage or processing of renderable text.

FIG. 9 illustrates an example method for implementing mechanisms for defining a text item, in accordance with an embodiment.

FIG. 10 illustrates an example method for implementing mechanisms for processing of a text item, in accordance with an embodiment.

FIG. 11 illustrates an example method for defining a data structure, in accordance with an embodiment.

FIG. 12 is a block diagram of one possible and non-limiting system in which the example embodiments may be practiced.

### DETAILED DESCRIPTION OF EXAMPLE EMBODIMENTS

The following acronyms and abbreviations that may be found in the specification and/or the drawing figures are defined as follows:
3GP 3GPP file format
3GPP 3rd Generation Partnership Project
3GPP TS 3GPP technical specification
4CC four character code
4G fourth generation of broadband cellular network technology
5G fifth generation cellular network technology
5GC 5G core network
ACC accuracy
AI artificial intelligence
AIoT AI-enabled IoT
ALF adaptive loop filtering
a.k.a. also known as
AMF access and mobility management function
APS adaptation parameter set
AVC advanced video coding
bpp bits-per-pixel
CABAC context-adaptive binary arithmetic coding
CDMA code-division multiple access
CE core experiment
cᵢ structure index
Ctu coding tree unit
CU central unit
DASH dynamic adaptive streaming over HTTP
DCT discrete cosine transform
DSP digital signal processor
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
FDMA frequency division multiple access
f(n) fixed-pattern bit string using n bits written (from left to right) with the left bit first.
F1 or F1-C interface between CU and DU control interface
gNB (or gNodeB) base station for 5G/NR, for example, a node providing NR user plane and control plane protocol terminations towards the UE, and connected via the NG interface to the 5GC
GSM Global System for Mobile communications
H.222.0 MPEG-2 Systems is formally known as ISO/IEC 13818-1 and as ITU-T Rec. H.222.0
H.26x family of video coding standards in the domain of the ITU-T
HLS high level syntax
IBC intra block copy
ID identifier
IEC International Electrotechnical Commission
IEEE Institute of Electrical and Electronics Engineers
I/F interface
IMD integrated messaging device
IMS instant messaging service
IoT internet of things
IP internet protocol
IRAP intra random access point
ISO International Organization for Standardization
ISOBMFF ISO base media file format
ITU International Telecommunication Union
ITU-T ITU Telecommunication Standardization Sector
JPEG joint photographic experts group
LMCS luma mapping with chroma scaling
LPA length of position array
LTE long-term evolution
LZMA Lempel-Ziv-Markov chain compression
LZMA2 simple container format that can include both uncompressed data and LZMA data
LZO Lempel-Ziv-Oberhumer compression
LZW Lempel-Ziv-Welch compression
MAC medium access control
mdat MediaDataBox
MME mobility management entity
MMS multimedia messaging service
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
MSB most significant bit
NAL network abstraction layer
NDU NN compressed data unit
ng or NG new generation
ng-eNB or NG-eNB new generation eNB
NN neural network
NNEF neural network exchange format
NNR neural network representation
NR new radio (5G radio)
N/W or NW network
ONNX Open Neural Network eXchange
PB protocol buffers
PC personal computer
PDA personal digital assistant
PDCP packet data convergence protocol
PHY physical layer
PID packet identifier
PLC power line communication
PNG portable network graphics
PSNR peak signal-to-noise ratio
RAM random access memory
RAN radio access network
RBSP raw byte sequence payload
RCᵢ structural tensor
RD loss rate distortion loss
RFC request for comments
RFID radio frequency identification
RLC radio link control
RRC radio resource control
RRH remote radio head
RTᵢ topology element tensor respectively
RU radio unit
Rx receiver
SDAP service data adaptation protocol
SGD Stochastic Gradient Descent
SGW serving gateway
SMF session management function
SMS short messaging service
SPS sequence parameter set
st(v) null-terminated string encoded as UTF-8 characters as specified in ISO/IEC 10646
SVC scalable video coding
S1 interface between eNodeBs and the EPC
TCP-IP transmission control protocol-internet protocol
TDMA time divisional multiple access
Trak TrackBox
TS transport stream
TUC technology under consideration
TV television
Tx transmitter
UE user equipment
ue(v) unsigned integer Exp-Golomb-coded syntax element with the left bit first
UICC Universal Integrated Circuit Card
UMTS Universal Mobile Telecommunications System
u(n) unsigned integer using n bits
UPF user plane function
URI uniform resource identifier
URL uniform resource locator
UTF-8 8-bit Unicode Transformation Format
VPS video parameter set
WLAN wireless local area network
X2 interconnecting interface between two eNodeBs in LTE network
Xn interface between two NG-RAN nodes

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a ‘computer-readable storage medium,’ which refers to a non-transitory physical storage medium (e.g., volatile or non-volatile memory device), can be differentiated from a ‘computer-readable transmission medium,’ which refers to an electromagnetic signal.

A method, apparatus and computer program product are provided in accordance with example embodiments for implementing mechanisms for carriage of renderable text. In some examples, the text item may be used with media items for providing annotations, cues, memes, and the like. Some examples of the media items, includes, but are not limited to, images, audio tracks, video tracks, haptic tracks, video games, and the like.

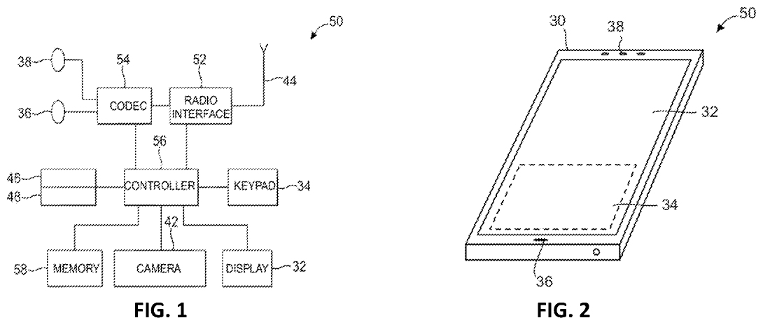

In an example, the following describes in detail suitable apparatus and possible for implementing mechanisms for carriage of renderable text. In this regard reference is first made to FIG. 1 and FIG. 2, where FIG. 1 shows an example block diagram of an apparatus 50. The apparatus may be an Internet of Things (IoT) apparatus configured to perform various functions, for example, gathering information by one or more sensors, receiving, or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 will be explained next.

The apparatus 50 may for example be a mobile terminal or user equipment of a wireless communication system, a sensor device, a tag, or a lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display media or multimedia content, for example, an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the examples described herein may be any one of: an earpiece 38, speaker, or an analogue audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

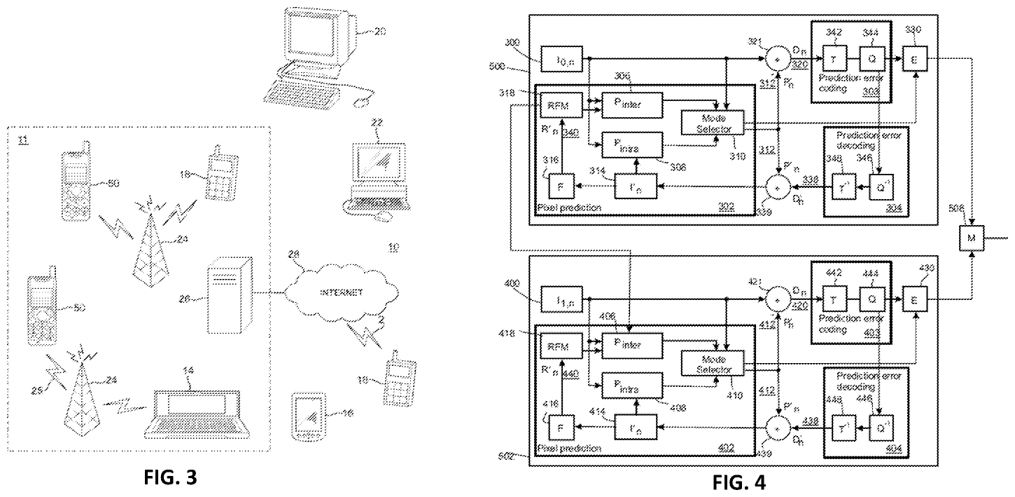

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network, and the like), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; for example, a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, and the like, to be included the Internet of Things (IoT). In order to utilize Internet IoT devices are provided with an IP address as a unique identifier. IoT devices may be provided with a radio transmitter, such as WLAN or Bluetooth transmitter or a RFID tag. Alternatively, IoT devices may have access to an IP-based network via a wired network, such as an Ethernet-based network or a power-line connection (PLC).

An MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

Video codec consists of an encoder that transforms the input video into a compressed representation suited for storage/transmission and a decoder that can decompress the compressed video representation back into a viewable form, or into a form that is suitable as an input to one or more algorithms for analysis or processing. A video encoder and/or a video decoder may also be separate from each other, for example, need not form a codec. Typically encoder discards some information in the original video sequence in order to represent the video in a more compact form (that is, at lower bitrate).

Typical hybrid video encoders, for example many encoder implementations of ITU-T H.263 and H.264, encode the video information in two phases. Firstly pixel values in a certain picture area (or ‘block’) are predicted for example by motion compensation means (finding and indicating an area in one of the previously coded video frames that corresponds closely to the block being coded) or by spatial means (using the pixel values around the block to be coded in a specified manner). Secondly the prediction error, for example, the difference between the predicted block of pixels and the original block of pixels, is coded. This is typically done by transforming the difference in pixel values using a specified transform (for example, Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction and current picture referencing), prediction is applied similarly to temporal prediction, but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra-coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives base layer picture(s)/image(s) 300 of a video stream to be encoded at both the inter-predictor 306 (which determines the difference between the image and a motion compensated reference frame) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture(s) 300. Correspondingly, the pixel predictor 402 of the second encoder section 502 receives enhancement layer picture(s)/images(s) of a video stream to be encoded at both the inter-predictor 406 (which determines the difference between the image and a motion compensated reference frame) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer pictures 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture(s) 300/enhancement layer picture(s) 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to the filter 316, 416. The filter 316, 416 receiving the preliminary representation may filter the preliminary representation and output a final reconstructed image 340, 440 which may be saved in the reference frame memory 318, 418. The reference frame memory 318 may be connected to the inter-predictor 306 to be used as the reference image against which a future base layer picture 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer picture(s) 400 is compared in inter-prediction operations. Moreover, the reference frame memory 418 may be connected to the inter-predictor 406 to be used as the reference image against which the future enhancement layer picture(s) 400 is compared in inter-prediction operations.

Filtering parameters from the filter 316 of the first encoder section 500 may be provided to the second encoder section 502 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, for example, the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 346, 446, which dequantizes the quantized coefficient values, for example, DCT coefficients, to reconstruct the transform signal and an inverse transformation unit 348, 448, which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide a compressed signal. The outputs of the entropy encoders 330, 430 may be inserted into a bitstream, for example, by a multiplexer 508.

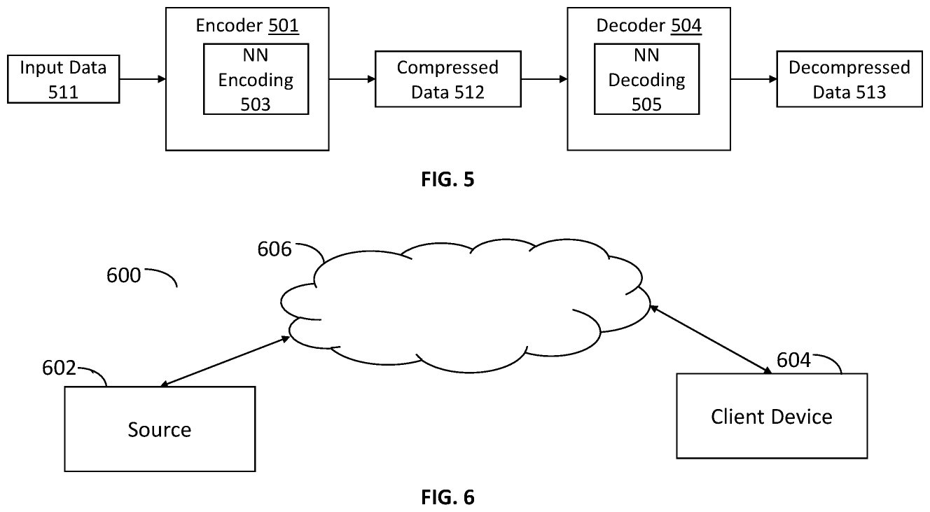

FIG. 5 is a block diagram showing the interface between an encoder 501 implementing neural network encoding 503, and a decoder 504 implementing neural network decoding 505 in accordance with the examples described herein. The encoder 501 may embody a device, software method or hardware circuit. The encoder 501 has the goal of compressing input data 511 (for example, an input video) to compressed data 512 (for example, a bitstream) such that the bitrate is minimized, and the accuracy of an analysis or processing algorithm is maximized. To this end, the encoder 501 uses an encoder or compression algorithm, for example to perform neural network encoding 503, e.g., encoding the input data by using one or more neural networks.

The general analysis or processing algorithm may be part of the decoder 504. The decoder 504 uses a decoder or decompression algorithm, for example to perform the neural network decoding 505 (e.g., decoding by using one or more neural networks) to decode the compressed data 512 (for example, compressed video) which was encoded by the encoder 501. The decoder 504 produces decompressed data 513 (for example, reconstructed data).

The encoder 501 and decoder 504 may be entities implementing an abstraction, may be separate entities or the same entities, or may be part of the same physical device.

An out-of-band transmission, signaling, or storage may refer to the capability of transmitting, signaling, or storing information in a manner that associates the information with a video bitstream. The out-of-band transmission may use a more reliable transmission mechanism compared to the protocols used for carrying coded video data, such as slices. The out-of-band transmission, signaling or storage can additionally or alternatively be used e.g. for ease of access or session negotiation. For example, a sample entry of a track in a file conforming to the ISO Base Media File Format may comprise parameter sets, while the coded data in the bitstream is stored elsewhere in the file or in another file. Another example of out-of-band transmission, signaling, or storage comprises including information, such as NN and/or NN updates in a file format track that is separate from track(s) containing coded video data.

The phrase along the bitstream (e.g. indicating along the bitstream) or along a coded unit of a bitstream (e.g. indicating along a coded tile) may be used in claims and described embodiments to refer to transmission, signaling, or storage in a manner that the ‘out-of-band’ data is associated with, but not included within, the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream. In another example, the phrase along the bitstream may be used when the bitstream is made available as a stream over a communication protocol and a media description, such as a streaming manifest, is provided to describe the stream.

The method and apparatus of an example embodiment may be utilized in a wide variety of systems, including systems that rely upon the compression and decompression of media data and possibly also the associated metadata. In one embodiment, however, the method and apparatus are configured to implement mechanisms for rendering of text item from a source via a content delivery network to a client device, at which point the text item that is used in conjunction with a media item is decompressed or otherwise processed. In this regard, FIG. 6 depicts an example of such a system 600 that includes a source 602 of media item and associated text item. The source may be, in one embodiment, a server. However, the source may be embodied in other manners if so desired. The source is configured to steam the media item and associated text item to a client device 604. The client device may be embodied by a media player, a multimedia system, a video system, a smart phone, a mobile telephone or other user equipment, a personal computer, a tablet computer or any other computing device configured to receive and process the media item and associated text item. In the illustrated embodiment, of the media item and associated text item are streamed via a network 606, such as any of a wide variety of types of wireless networks and/or wireline networks. The client device is configured to receive structured information containing media, metadata and any other relevant representation of information containing the media and the metadata and to decompress the media data and process the associated metadata (e.g. for proper playback timing of decompressed media data).

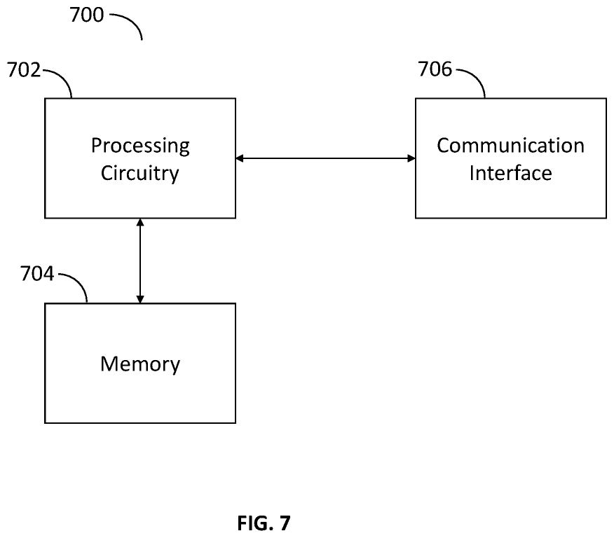

An apparatus 700 is provided in accordance with an example embodiment as shown in FIG. 7. In one embodiment, the apparatus of FIG. 7 may be embodied by the source 602, such as a file writer which, in turn, may be embodied by a server, that is configured to stream a media item and associated text item; or a compressed representation of the media data and associated metadata. In an alternative embodiment, the apparatus may be embodied by the client device 604, such as a file reader which may be embodied, for example, by any of the various computing devices described above. In either of these embodiments and as shown in FIG. 7, the apparatus of an example embodiment includes, is associated with or is in communication with a processing circuitry 702, one or more memory devices 704, a communication interface 706 and optionally a user interface.

The processing circuitry 702 may be in communication with the memory device 704 via a bus for passing information among components of the apparatus 700. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 700 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single ‘system on a chip.’ As such, in some cases, a chip or chipset may constitute means for performing one or more operations for providing the functionalities described herein.

The processing circuitry 702 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 702 may be configured to execute instructions stored in the memory device 704 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processing circuitry to perform the algorithms and/or operations described herein when the instructions are executed. However, in some cases, the processing circuitry may be a processor of a specific device (e.g., an image or video processing system) configured to employ an embodiment of the present invention by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 706 may be any means such as a device or circuitry embodied in either hardware or a combination of hardware and software that is configured to receive and/or transmit data, including video bitstreams. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the apparatus 700 may optionally include a user interface that may, in turn, be in communication with the processing circuitry 702 to provide output to a user, such as by outputting an encoded video bitstream and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processing circuitry may comprise user interface circuitry configured to control at least some functions of one or more user interface elements such as a display and, in some embodiments, a speaker, ringer, microphone and/or the like. The processing circuitry and/or user interface circuitry comprising the processing circuitry may be configured to control one or more functions of one or more user interface elements through computer program instructions (e.g., software and/or firmware) stored on a memory accessible to the processing circuitry (e.g., memory device, and/or the like).

In an embodiment, the apparatus 700 is configured to implement mechanisms carriage of renderable text.

### ISO Base Media File Format

Available media file format standards include International Standards Organization (ISO) base media file format (ISO/IEC 14496-12, which may be abbreviated ISOBMFF), Moving Picture Experts Group (MPEG)-4 file format (ISO/IEC 14496-14, also known as the MP4 format), file format for NAL (Network Abstraction Layer) unit structured video (ISO/IEC 14496-15) and High Efficiency Video Coding standard (HEVC or H.265/HEVC).

Some concepts, structures, and specifications of ISOBMFF are described below as an example of a container file format, based on which some embodiments may be implemented. The features of the disclosure are not limited to ISOBMFF, but rather the description is given for one possible basis on top of which at least some embodiments may be partly or fully realized.

A basic building block in the ISO base media file format is called a box. Each box has a header and a payload. The box header indicates the type of the box and the size of the box in terms of bytes. A box type is typically identified by an unsigned 32-bit integer, interpreted as a four character code (4CC). A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

In files conforming to the ISO base media file format, the media data may be provided in one or more instances of MediaDataBox (‘mdat’) and the MovieBox (‘moov’) may be used to enclose the metadata for timed media. In some examples, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks may be collectively called media tracks, and they contain an elementary media stream. Other track types comprise hint tracks and timed metadata tracks.

Tracks comprise samples, such as audio or video frames. For video tracks, a media sample may correspond to a coded picture or an access unit.

A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

The ‘trak’ box includes, in its hierarchy of boxes, a SampleDescriptionBox, which gives detailed information about the coding type used, and any initialization information needed for that coding. The SampleDescriptionBox contains an entry-count and as many sample entries as the entry-count indicates. The format of sample entries is track-type specific but derived from generic classes (e.g. VisualSampleEntry, AudioSampleEntry). A media handler of the track determines which type of sample entry form is used for derivation of the track-type specific sample entry format.

The track reference mechanism may be used to associate tracks with each other. The TrackReferenceBox includes box(es), each of which provides a reference from the containing track to a set of other tracks. These references are labeled through the box type (e.g., the four-character code of the box) of the contained box(es).

The ISO base media file format contains three mechanisms for timed metadata that may be associated with particular samples: sample groups, timed metadata tracks, and sample auxiliary information. A derived specification may provide similar functionality with one or more of these three mechanisms.

A sample grouping in the ISO base media file format and its derivatives, such as the advanced video coding (AVC) file format and the scalable video coding (SVC) file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that may be used e.g. to indicate a sub-type of the grouping.

In ISOMBFF, an edit list provides a mapping between the presentation timeline and the media timeline. Among other things, an edit list provides for the linear offset of the presentation of samples in a track, provides for the indication of empty times and provides for a particular sample to be dwelled on for a certain period of time. The presentation timeline may be accordingly modified to provide for looping, such as for the looping videos of the various regions of the scene. One example of the box that includes the edit list, the EditListBox, is provided below:

```
aligned(8) class EditListBox extends FullBox('elst', version, flags) {
unsigned int(32) entry_count;
  for (i=1; i <= entry_count; i++) {
    if (version==1) {
      unsigned int(64) segment_duration;
      int(64) media_time;
  } else { // version==0
      unsigned int(32) segment_duration;
      int(32) media_time;
  }
  int(16) media_rate_integer;
  int(16) media_rate_fraction = 0;
  }
}
```

In ISOBMFF, an EditListBox may be contained in EditBox, which is contained in TrackBox (‘trak’).

In this example of the edit list box, flags specifies the repetition of the edit list. By way of example, setting a specific bit within the box flags (the least significant bit, i.e., flags & 1 in ANSI-C notation, where & indicates a bit-wise AND operation) equal to 0 specifies that the edit list is not repeated, while setting the specific bit (i.e., flags & 1 in ANSI-C notation) equal to 1 specifies that the edit list is repeated. The values of box flags greater than 1 may be defined to be reserved for future extensions. As such, when the edit list box indicates the playback of zero or one samples, (flags & 1) shall be equal to zero. When the edit list is repeated, the media at time 0 resulting from the edit list follows immediately the media having the largest time resulting from the edit list such that the edit list is repeated seamlessly.

In ISOBMFF, a Track group enables grouping of tracks based on certain characteristics or the tracks within a group have a particular relationship. Track grouping, however, does not allow any image items in the group.

The syntax of TrackGroupBox in ISOBMFF is as follows

```
aligned(8) class TrackGroupBox extends Box('trgr') {
}
aligned(8) class TrackGroupTypeBox(unsigned int(32) track_group_type)
extends FullBox(track_group_type, version = 0, flags = 0)
{
  unsigned int(32) track_group_id;
  // the remaining data may be specified for a particular track_group_type
}
```

track_group_type indicates the grouping_type and shall be set to one of the following values, or a value registered, or a value from a derived specification or registration.

‘msrc’ indicates that this track belongs to a multi-source presentation. The tracks that have the same value of track_group_id within a TrackGroupTypeBox of track_group_type ‘msrc’ are mapped as being originated from the same source. For example, a recording of a video telephony call may have both audio and video for both participants, and the value of track_group_id associated with the audio track and the video track of one participant differs from value of track_group_id associated with the tracks of the other participant.

The pair of track_group_id and track_group_type identifies a track group within the file. The tracks that contain a particular TrackGroupTypeBox having the same value of track_group_id and track_group_type.

The Entity grouping is similar to track grouping but enables grouping of both tracks and image items in the same group.

The syntax of EntityToGroupBox in ISOBMFF is as follows:

```
aligned(8) class EntityToGroupBox(grouping_type, version, flags)
extends FullBox(grouping_type, version, flags) {
  unsigned int(32) group_id;
  unsigned int(32) num_entities_in_group;
  for(i=0; i<num_entities_in_group; i++)
    unsigned int(32) entity_id;
}
```

group_id is a non-negative integer assigned to the particular grouping that shall not be equal to any group_id value of any other EntityToGroupBox, any item_ID value of the hierarchy level (file, movie, or track) that includes the GroupsListBox, or any track_ID value (when the GroupsListBox is contained in the file level).

num_entities_in_group specifies the number of entity_id values mapped to this entity group.

entity_id is resolved to an item, when an item with item_ID equal to entity_id is present in the hierarchy level (file, movie or track) that contains the GroupsListBox, or to a track, when a track with track_ID equal to entity_id is present and the GroupsListBox is contained in the file level.

Files conforming to the ISOBMFF may contain any non-timed objects, referred to as items, meta items, or metadata items, in a meta box (four-character code: ‘meta’). While the name of the meta box refers to metadata, items can generally contain metadata or media data. The meta box may reside at the top level of the file, within a movie box (four-character code: ‘moov’), and within a track box (four-character code: ‘trak’), but at most one meta box may occur at each of the file level, movie level, or track level. The meta box may be required to contain a ‘hdlr’ box indicating the structure or format of the ‘meta’ box contents. The meta box may list and characterize any number of items that can be referred and each one of them can be associated with a file name and are uniquely identified with the file by item identifier (item_id) which is an integer value. The metadata items may be for example stored in the ‘idat’ box of the meta box or in an ‘mdat’ box or reside in a separate file. If the metadata is located external to the file then its location may be declared by the DataInformationBox (four-character code: ‘dinf’). In the specific case that the metadata is formatted using eXtensible Markup Language (XML) syntax and is required to be stored directly in the MetaBox, the metadata may be encapsulated into either the XMLBox (four-character code: ‘xml’) or the BinaryXMLBox (four-character code: ‘bxml’). An item may be stored as a contiguous byte range, or it may be stored in several extents, each being a contiguous byte range. In other words, items may be stored fragmented into extents, e.g. to enable interleaving. An extent is a contiguous subset of the bytes of the resource. The resource can be formed by concatenating the extents.

The ItemPropertiesBox enables the association of any item with an ordered set of item properties. Item properties may be regarded as small data records. The ItemPropertiesBox consists of two parts: ItemPropertyContainerBox that contains an implicitly indexed list of item properties, and one or more ItemPropertyAssociationBox(es) that associate items with item properties.

The ItemInfoBox provides extra information about selected items, including symbolic (‘file’) names. ItemInfoBox may be optionally included, but when it is included, it may be interpreted, as item protection or content encoding may have changed the format of the data in the item. When both content encoding and protection are indicated for an item, a reader should first un-protect the item, and then decode the item's content encoding. When more control is needed, an IPMP sequence code may be used.

ItemInfoBox contains an array of entries, and each entry is formatted as a box. This array may be sorted by increasing item_ID in the entry records. The item_name may be a valid URL (e.g. a simple name, or path name) and may not be an absolute URL.

Currently, four versions of the item info entry are defined. Version 1 includes additional information to version 0 as specified by an extension type. For instance, it shall be used with extension type ‘fdel’ for items that are referenced by the FilePartitionBox, which is defined for source file partitionings and applies to file delivery transmissions. Versions 2 and 3 provide an alternative structure in which metadata item types are indicated by a 32-bit registered or defined code (typically a four character code); two of these codes are defined to indicate a MIME type or metadata typed by a URI. Version 2 supports 16-bit item_ID values, whereas version 3 supports 32-bit item_ID values.

When no extension is desired, the box may terminate without the extension_type field and the extension; if, in addition, content_encoding is not desired, that field also may be absent, and the box terminate before it. When an extension is desired without an explicit content_encoding, a single null byte, signifying the empty string, may be supplied for the content_encoding, before the indication of extension_type.

When file delivery item information is needed and a version 2 or 3 ItemInfoEntry is used, the file delivery information is stored as a separate item of type ‘fdel’ that is also linked by an item reference from the item, to the file delivery information, of type ‘fdel’. There may be exactly one such reference if file delivery information is needed.

It is possible that there are valid URI forms for MPEG-7 metadata as defined in ISO/IEC 15938-1 (e.g. a schema URI with a fragment identifying a particular element), and it may be possible that these structures could be used for MPEG-7. However, there is explicit support for MPEG-7 in ISO base media file format family files, and this explicit support is preferred as it allows, among other things:
incremental update of the metadata (logically, I/P coding, in video terms) whereas this draft is ‘I-frame only’;
binarization and thus compaction; and/or
the use of multiple schemas.

Therefore, the use of these structures for MPEG-7 is deprecated (and undocumented). Information on URI forms for some metadata systems can be found in Annex G.

Version 1 of ItemInfoBox should only be used when support for a large number of itemInfoEntries (exceeding 65535) is required or expected to be required.

The flags field of ItemInfoEntry with version greater than or equal to 2 is specified as follows:
(flags & 1) equal to 1 indicates that the item is not intended to be a part of the presentation.
(flags & 1) equal to 0 indicates that the item is intended to be a part of the presentation.

The syntax of ItemInfoBox and its related entries in ISOBMFF are as follows: aligned(8) class ItemInfoExtension(unsigned int(32) extension_type)

```
{
}
aligned(8) class FDItemInfoExtension() extends ItemInfoExtension ('fdel') {
  utf8string content_location;
  utf8string content_MD5;
  unsigned int(64) content_length;
  unsigned int(64) transfer_length;
  unsigned int(8) entry_count;
  for (i=1; i <= entry_count; i++)
    unsigned int(32) group_id;
}
aligned(8) class ItemInfoEntry
    extends FullBox('infe', version, flags) {
  if ((version == 0) || (version == 1)) {
    unsigned int(16) item_ID;
    unsigned int(16) item_protection_index;
    utf8string item_name;
    utf8string content_type;
    utf8string content_encoding; //optional
  }
  if (version == 1) {
    unsigned int(32) extension_type; //optional
    ItemInfoExtension(extension_type); //optional
  }
  if (version >= 2) {
    if (version == 2) {
      unsigned int(16) item_ID;
    } else if (version == 3) {
      unsigned int(32) item_ID;
    }
    unsigned int(16) item_protection_index;
    unsigned int(32) item_type;
    utf8string item_name;
    if (item_type=='mime') {
      utf8string content_type;
      utf8string content_encoding; //optional
    } else if (item_type == 'uri ') {
      utf8string item_uri_type;
    }
  }
}
aligned(8) class ItemInfoBox
    extends FullBox('iinf', version, 0) {
  if (version == 0) {
```

| | |
|---|---|
| unsigned int(16) | entry_count; |

```
  } else {
    unsigned int(32) entry_count;
  }
```

| | |
|---|---|
| ItemInfoEntry[ entry_count ] | item_infos; |

}

item_ID contains either 0 for the primary resource (e.g., the XML contained in an XMLBox) or the ID of the item for which the following information is defined.

item_protection_index contains either 0 for an unprotected item, or the index, with value 1 indicating the first entry, into the ItemProtectionBox defining the protection applied to this item (the first box in the ItemProtectionBox has the index 1).

item_name is the symbolic name of the item (source file for file delivery transmissions).

item_type is a 32-bit value, typically 4 printable characters, that is a defined valid item type indicator, such as ‘mime’.

content_type is the MIME type of the item. If the item is content encoded (see below), then the content type refers to the item after content decoding.

item_uri_type is an absolute URI, that is used as a type indicator.

content_encoding optionally indicates that the binary file is encoded and needs to be decoded before interpreted. The values are as defined for Content-Encoding for HTTP/1.1. Some possible values are “gzip”, “compress” and “deflate”. An empty string indicates no content encoding. Note that the item is stored after the content encoding has been applied.

extension_type is a four character code that identifies the extension fields of version 1 with respect to version 0 of the Item information entry.

content_location contains the URI of the file as defined in HTTP/1.1 (IETF RFC 2616[8]).

content_MD5 contains an MD5 digest of the file. See HTTP/1.1 (IETF RFC 2616[8]) and IETF RFC 1864[7].

content_length gives the total length (in bytes) of the (un-encoded) file.

transfer_length gives the total length (in bytes) of the (encoded) file. Transfer length is equal to content length when no content encoding is applied.

entry_count provides a count of the number of entries in the following array.

group_ID indicates a file group to which the file item (source file) belongs. See 3GPP TS 26.346[2] for more details on file groups.

### High Efficiency Image File Format (HEIF)

High efficiency image file format (HEIF) is a standard developed by the moving picture experts group (MPEG) for storage of images and image sequences. Among other things, the standard facilitates file encapsulation of data coded according to the high efficiency video coding (HEVC) standard. HEIF includes features building on top of the used ISO base media file format (ISOBMFF).

The ISOBMFF structures and features are used to a large extent in the design of HEIF. The basic design for HEIF comprises still images that are stored as items and image sequences that are stored as tracks.

In the context of HEIF, the following boxes may be contained within the root-level ‘meta’ box and may be used as described in the following. In HEIF, the handler value of the handler box of the ‘meta’ box is ‘pict’. The resource (whether within the same file, or in an external file identified by a uniform resource identifier) containing the coded media data is resolved through the data information (‘dinf’) box, whereas the item location (‘iloc’) box stores the position and sizes of every item within the referenced file. The item reference (‘iref’) box documents relationships between items using typed referencing. If there is an item among a collection of items that is in some way to be considered the most important compared to others then this item is signaled by the primary item (‘pitm’) box. Apart from the boxes mentioned here, the ‘meta’ box is also flexible to include other boxes that may be necessary to describe items.

Any number of image items can be included in the same file. Given a collection of images stored by using the ‘meta’ box approach, it sometimes is essential to qualify certain relationships between images. Examples of such relationships include indicating a cover image for a collection, providing thumbnail images for some or all of the images in the collection, and associating some or all of the images in a collection with an auxiliary image such as an alpha plane. A cover image among the collection of images is indicated using the ‘pitm’ box. A thumbnail image or an auxiliary image is linked to the primary image item using an item reference of type ‘thmb’ or ‘auxl’, respectively.

Images may be assigned different roles or purposes as specified in the following subclauses. The role or the purpose is independent of whether the image is represented by a coded image or a derived image, or how the image is coded or transformed (by a transformative item property).

The role of an image can be indicated with a qualifier, such as hidden, or thumbnail, in front of the term image, e.g., hidden image, or thumbnail image. When referring to an image item that contains an image with a specific role, the role qualifier can precede the term image item, e.g. hidden image item, or thumbnail image item.

Many of the roles specified below are not mutually exclusive. Consequently, the same image may have multiple roles. An example of an image with multiple roles is a hidden auxiliary image.

A hidden image item has (flags & 1) equal to 1 in its ItemInfoEntry. Readers should not display a hidden image item. A hidden image item can be, for example, an image item that is used as an input image for a derived image item but is never intended to be displayed itself.

The primary item shall not be a hidden image item.

Any entity group of type ‘altr’ that includes image items, may either include only hidden items or only non-hidden items (e.g., a group of this type cannot contain a mix of hidden and non-hidden items).

For a collection of images carried as items in a MetaBox, the primary item of the MetaBox should be displayed when no other information is available on the preference to display a collection of images.

A thumbnail image is a smaller-resolution representation of a master image. The thumbnail image and the master image are linked using a reference type ‘thmb’ from the thumbnail image to the master image. A thumbnail image may not be linked to another thumbnail image with the ‘thmb’ item reference.

The RelativeLocationProperty descriptive item property is used to describe the horizontal and vertical position of the reconstructed image of the associated image item relative to the reconstructed image of the related image item identified through the ‘tbas’ item reference as specified below. The pixel sampling of the associated image item may be identical or substantially identical to that of the related image item and the sampling grids of the associated image item and the related image item may be aligned (e.g., not have a sub-pixel offset). Consequently, one pixel in the associated image item collocates to exactly one pixel in the related image item. The related image item shall be identified by an item reference of type ‘tbas’ from the associated image item to the related image item.

The syntax of RelativeLocationProperty is defined below:

```
aligned(8) class RelativeLocationProperty
extends ItemFullProperty('rloc', version = 0, flags = 0)
{
  unsigned int(32) horizontal_offset;
  unsigned int(32) vertical_offset;
}
```

where the horizontal_offset specifies the horizontal offset in pixels of the left-most pixel column of the reconstructed image of the associated image item in the reconstructed image of the related image item. The left-most pixel column of the reconstructed image of the related image item has a horizontal offset equal to 0.

vertical_offset specifies the vertical offset in pixels of the top-most pixel row of the reconstructed image of the associated image item in the reconstructed image of the related image item. The top-most pixel row of the reconstructed image of the related image item has a vertical offset equal to 0.

An item with an item_type value of ‘iovl’ defines a derived image item by overlaying one or more input images in a given layering order within a larger canvas. The input images are listed in the order they are layered, i.e. the bottom-most input image first and the top-most input image last, in the SingleItemTypeReferenceBox of type ‘dimg’ for this derived image item within the ItemReferenceBox.

In an embodiment, file writers need to be careful when removing an item that is marked as an input image of an image overlay item, as the content of the image overlay item might need to be rewritten.

The syntax of ImageOverlay is defined below.

```
aligned(8) class ImageOverlay {
  unsigned int(8) version = 0;
  unsigned int(8) flags;
  for (j=0; j<4; j++) {
    unsigned int(16) canvas_fill_value;
  }
  unsigned int FieldLength = ((flags & 1) + 1) * 16; // this is a temporary,
non-parsable variable
  unsigned int(FieldLength) output_width;
  unsigned int(FieldLength) output_height;
  for (i=0; i<reference_count; i++) {
    signed int(FieldLength) horizontal_offset;
    signed int(FieldLength) vertical_offset;
  }
}
```

version shall be equal to 0.

(flags & 1) equal to 0 specifies that the length of the fields output_width, output_height, horizontal_offset, and vertical_offset is 16 bits. (flags & 1) equal to 1 specifies that the length of the fields output_width, output_height, horizontal_offset, and vertical_offset is 32 bits. The values of flags greater than 1 are reserved.

canvas_fill_value: indicates the pixel value per channels used when no pixel of any input image is located at a particular pixel location. The fill values are specified as RGBA (R, G, B, and A corresponding to loop counter j equal to 0, 1, 2, and 3, respectively). The RGB values are in the sRGB color space as defined in IEC 61966-2-1. The A value is a linear opacity value ranging from 0 (fully transparent) to 65535 (fully opaque).

output_width, output_height: Specify the width and height, respectively, of the reconstructed image on which the input images are placed. The image area of the reconstructed image is referred to as the canvas.

reference_count is obtained from the SingleItemTypeReferenceBox of type ‘dimg’ where this item is identified by the from_item_ID field.

horizontal_offset, vertical_offset: Specifies the offset, from the top-left corner of the canvas, to which the input image is located. Pixel locations with a negative offset value are not included in the reconstructed image. Horizontal pixel locations greater than or equal to output_width are not included in the reconstructed image. Vertical pixel locations greater than or equal to output_height are not included in the reconstructed image.

### Timed Text and Other Visual Overlays in ISO Base Media File Format

ISO/IEC 14496-30 Timed text and other visual overlays in ISO base media file format, describes the carriage of some forms of timed text and subtitle streams in files based on ISO/IEC 14496-12 The ISO base media file format. The documentation of these forms does not preclude other definition of carriage of timed text or sub-titles; see, for example, 3GPP Timed Text (3GPP TS 26.245).

This part of ISO/IEC 14496 enables timed text and subtitle streams to:
be used in conjunction with other media streams, such as audio or video,
be used in an MPEG-4 systems environment, if desired,
be formatted for delivery by a streaming server, using hint tracks, and
inherit all the use cases and features of the ISO base media file format on which MP4 and MJ2 are based.

ISO/IEC 14496-30 Timed text and other visual overlays in ISO base media file format defines common layout behavior for processing of timed text or subtitle samples.

Unless specified by an embedding environment (e.g. an HTML page), the track header box information (e.g. width, height) shall be used to size the subtitle or timed text track content with respect to the associated track(s) as follows:
when the flag track_size_is_aspect_ratio is not set, and the track width and height are set to values different from 0, the size of the timed text track shall be the track width and height.
when the flag track_size_is_aspect_ratio is not set, and the track width and height are set to 0, the size of the timed text track shall match the reference size.
when the flag track_size_is_aspect_ratio is set, it indicates that the content of the track was authored to an aspect ratio equal to the track header width/height. In this case, neither width nor height shall be 0. The timed text track shall be sized to the maximum size that will fit within the reference size and should equal its width or height, while preserving the indicated aspect ratio.

When only one track is associated with the timed text track, the reference size is the size of the associated track. When multiple tracks are associated and/or when the multiple media items are alternate to each other, the reference size is the size of the composition of tracks as described by the matrices in the track headers of the associated tracks.

Upon file creation, the width and height of the subtitle or timed text track should be set appropriately according to the width and height of the associated track(s), as declared in their track header. A typical usage is that the timed text or subtitle track has the same width and height as an associated visual track, and no translation.

When the track is supposed to overlay is not stored in an ISOBMFF file or when it is stored as a track in a different ISOBMFF file, the values 0x0 may be used; or the track_size_is_aspect_ratio flag may be used and the width and height set to the desired aspect ratio.

For some timed text documents, the region as defined by the width, height and track_size_is_aspect_ratio corresponds to the visual area filled by the rendering of the timed text documents.

When the track width and height attributes are set to a value different from 0 and the track_size_is_aspect_ratio_flag may not be used, additional region positioning using the translation values tx and ty from the track header matrix, as defined for 3GPP Timed Text tracks, may be used (3GPP TS 26.245, section 5.7, provides the definition of the text track region using tx, ty, and the track width and height, and is herein incorporated by reference).

Unless specified by an embedding environment (e.g. an HTML page), visually composed tracks including video, subtitle, and timed text shall be stacked or layered using the ‘layer’ value in the track header box. The layer field provides the same functionality as z-index in TTML.

Timed text and subtitle tracks are normally stacked in front of the associated visual track(s).

ISO/IEC 14496-30 defines common timing behavior for processing of timed text or subtitle samples.

The general processing of timed text or subtitle tracks is that the text content of the sample is delivered to the decoder at the sample decode time, at the latest. The rendering of the sample happens at the composition time, taking into account edit lists if any, and for the whole sample duration, without timing behavior. However, timed text or subtitle sample data of specific formats may contain internal timing values. Internal timing values may alter the rendering of the sample during its duration as specified by the timed text or subtitle format.

When an internal timing value does not fall in the time interval corresponding to the sample composition time and sample composition time plus sample duration, the rendering of the sample may be different from the rendering of the same sample data with a composition time such that the internal timing value lies in the associated composition interval.

ISO/IEC 14496-30 specify how internal timing values relate to the track time or to the sample decode or composition time. For instance, start or end times may be relative to the start of the sample, or the start of the track.

For sections of the track timeline that have no associated subtitles or timed text content, ‘empty’ samples may be used, as defined for each format, or the duration of the preceding sample extended. Samples with a size of zero are not used.

The timescale field in the media header box should be set appropriately to achieve the desired timing accuracy. It is recommended to be set to the value of the timescale field in the media header box of (one of) the associated track(s).

Timed text tracks should be marked with a suitable language in the media header box, indicating the audience for whom the track is appropriate. In the case where it is suitable for a single language, the media header must match that declared language. The value ‘mul’ may be used for a multi-lingual text.

Common resources, such as images and fonts, that are referred to by URLs, may be stored as items in a MetaBox as defined by ISO/IEC 14496-12. These items may be addressed by using the item_name as a relative URL in the timed text sample, as defined by 8.11.9 of ISO/IEC 14496-12.

A derived specification, with its applicable brand, may restrict this use of meta boxes for common items.

Fonts not supplied with the content may be already present on the target system(s), or supplied using any suitable supported mechanism (e.g. font streaming as defined in ISO/IEC 14496-18).

Timed text tracks may be explicitly or implicitly associated with other tracks in the file. They are explicitly associated with a track when the timed text track uses a track reference of type ‘subt’ to that track, as defined in ISO/IEC 14496-12, or to a track in the same alternate group. If no ‘subt’ track reference is used, the timed text track is said to be implicitly associated to all tracks in the file. In particular, if track groups are not used, the timed text track is associated to all tracks in the file. Association is used to indicate which track(s) a timed text track is intended to overlay and may be used to determine the desired rendered size when that information is not provided in the track header of the timed text track. Timed text and subtitle tracks may be associated with any type of track, including visual tracks (e.g. video tracks, graphics tracks, image tracks) or audio tracks as determined by some external context.

ISO/IEC 14496-30 describes how documents based on TTML, as defined by the W3C, and derived specifications (for example SMPTE-TT), are carried in files based on the ISO base media file format. A TTML Track is a track carrying TTML documents, which may be documents that correspond to a specification based on TTML.

For TTML tracks the track width and height provide the spatial extent of the root container, as defined in the TTML Recommendation. Any ‘extent’ attribute declared on the ‘tt’ element in the contained TTML document shall match the track width and height. If the ‘extent’ attribute is not declared on the ‘tt’ element in the contained TTML document, the track header width and height may be set to 0 or to any desired size.

This is used when the document is authored in a resolution-independent manner (e.g. using percentage layout).

Alternatively, when a resolution-independent document has been authored to a specific aspect ratio (whether or not the aspect ratio is explicitly signalled in the document) the track_size_is_aspect_ratio flag may be used to signal the authored aspect ratio. In this case, the track header width and height shall be set to values that indicate the authored aspect ratio (e.g. 16 by 9).

The top-level internal timing values in the timed text samples based on TTML express times on the track presentation timeline—that is, the track media time as optionally modified by the edit list. For example, the begin and end attributes of the <body> element, if used are relative to the start of the track, not relative to the start of the sample.

No transport layer buffer or timing model is defined to guarantee that subtitle content can be read and processed in time to be synchronously presented with audio and video. It is assumed that users of this track format will define timed text content profiles and hypothetical render models that will constrain content parameters so that compatible decoders may identify and decode those profiles for synchronous presentation.

The following document constraints may need to be specified to define a timed text profile that will guarantee synchronous decoding of conforming content on conforming decoders:
Maximum allowed document size;
Number of document buffers in the hypothetical render model;
Video overlay timing of the hypothetical render model;
Maximum total compressed image size in megabytes per sample;
Maximum total decoded image size in megapixels per sample;
Maximum decoded image dimensions;
Maximum text rendering rate required by a document;
Maximum image rendering rate required by a document;
Maximum number of simultaneously displayed characters;
Maximum font size; and/or
Maximum number of simultaneously displayed images.

Providing a method to signal an externally defined timed text profile in the subtitle sample description is possible using the sample entry description.

An ‘empty’ sample is defined as containing a TTML document that has no content. A TTML document that has no content is any document that contains (a) no<div> element or (b) no <body> element or (c) no<span> elements containing character data or <br> elements; for example, the following document:
[<tt xmlns=“http://www.w3.org/ns/ttml”/> (last accessed on Oct. 4, 2021)]

The duration of the TTML document carried in a sample may be less than the sample duration, but should not be greater.

TTML streams shall be carried in subtitle tracks, and as a consequence according to ISOBMFF, the media handler type is ‘subt’, and the track uses a subtitle media header, and associated sample entry and sample group base class.

TTML streams shall use the XMLSubtitleSampleEntry format.

The namespace field shall be set to at least one unique namespace. It should be set to indicate the primary TTML-based namespace of the document, and should be set to all namespaces in use in the document (e.g. TTML+TTML-Styling+SMPTE-TT).

The schema_location field should be set to schema pathnames that uniquely identify the profile or constraint set of the namespaces included in the namespace field.

When sub-samples are present, then the auxiliary_mime_types field shall be set to the mime types used in the sub-samples—e.g. “image/png”.

A TTML subtitle sample shall consist of an XML document, optionally with resources such as images referenced by the XML document. Every sample is therefore a sync sample in this format; hence, the sync sample table is not present.

Other resources such as images are optional. Resources referenced by an XML document may be stored in the same subtitle sample as the document that references them, in which case they shall be stored contiguously following the XML document that references those resources. Resources should be stored in presentation time order.

When resources are stored in a sample, the Track Fragment Box (‘traf’) shall contain a Sub-Sample Information Box (‘subs’) constrained as follows:
entry_count and sample_delta shall be set to 1 since each subtitle track fragment contains a single subtitle sample;
subsample_count shall be set to the number of resources plus 1; and/or
subsample_priority and discardable have no meaning; they shall be set to zero on encoding and may be ignored by decoders.

When sub-samples are used, the XML document shall be the first sub-sample entry. Each resource the document references shall be defined as a subsequent sub-sample in the same table.

The XML document shall reference each sub-sample object using a URI, as per RFC3986. When a URN is used, it shall be of the form:
urn:<nid>: . . . :<index>[.<ext>]
Where:
<nid> is the registered URN namespace ID per RFC 2141.
<index> is the sub-sample index “j” in the ‘subs’ referring to the object in question.
<ext> is an optional file extension—e.g. “png”.

The first resource in the sample will have a sub-sample index value of 1 in the ‘subs’ and that will be the index used to form the URI.

Reference the same object can be made multiple times within an XML document. In such instances, there will be only one sub-sample entry in the Sub-Sample Information Box for that object, and the URN's used to reference the object each time will be identical.

WebVTT text content in tracks is encoded using UTF-8, and the data-type boxstring indicates an array of UTF-8 bytes, to fill the enclosing box, with neither a leading character count nor a trailing null terminator.

Each WebVTT cue, as defined in the WebVTT specification, is stored de-constructed, partly to emphasize that the textual timestamps one would normally find in a WebVTT file do not determine presentation timing; the ISO file structures do. It also separates the text of the actual cue from the structural information that the WebVTT file carries (positioning, timing, and so on). WebVTT cues are stored in a typical ISO boxed structured approach to enable interfacing an ISO file reader with a WebVTT renderer without the need to serialize the sample content as WebVTT text and to parse it again.

Boxes shall not contain trailing CR or LF characters, or trailing CRLF sequences (where ‘trailing’ means that they occur last in the payload of the box).

WebVTT streams shall be carried as timed text tracks, and as a consequence according to ISOBMFF, use the ‘text’ media handler type, and the associated media header, sample entry, and sample group base class.

WebVTT streams shall use the WVTTSampleEntry format. In the sample entry, a WebVTT configuration box must occur, carrying exactly the lines of the WebVTT file header, i.e. all text lines up to but excluding the ‘two or more line terminators’ that end the header.

In some implementations, other boxes may be defined for the sample entry in future revisions of this specification (e.g. carrying optional CSS style sheets, font information, and so on).

A WebVTT source label box should occur in the sample entry. It contains a suitable string identifier of the ‘source’ of this WebVTT content, such that if a file is made by editing together two pieces of content, the timed text track would need two sample entries because this source label differs. A URI is recommended for the source label; however, the URI is not interpreted and may not be required there be a resource at the indicated location when a URL form is used.

The ‘codecs’ parameter for WebVTT streams as defined in RFC6381 uses only one element, the four-character code of the sample description entry for the stream, e.g. ‘wvtt’.

class WebVTTConfigurationBox extends Box('vttC') {

| | |
|---|---|
| boxstring | config; |

}
class WebVTTSourceLabelBox extends Box('vlab') {

| | |
|---|---|
| boxstring | source_label; |

}
class WVTTSampleEntry( ) extends PlainTextSampleEntry ('wvtt'){

| | |
|---|---|
| WebVTTConfigurationBox | config; |
| WebVTTSourceLabelBox | label; // recommended |
| MPEG4BitRateBox ( ); | // optional |
| } | |

The character replacements as specified in step 1 of the WebVTT parsing algorithm, may be applied before VTT data is stored in this format. Readers should be prepared to apply these replacements when integrated directly with a WebVTT renderer.

Each sample is either:
exactly one VTTEmptyCueBox box (representing a period of non-zero duration in which there is no cue data) or
one or more VTTCueBox boxes that share the same start time and end time, each containing the following boxes. Only the CuePayloadBox is mandatory, all others are optional. A sample containing cue boxes may also contain zero or more VTTAdditionalTextBox boxes, interleaved between VTTCueBox boxes and carrying any other text in between cues, in the order required by the processing of the additional text, if any.

The VTTCueBox boxes must be in presentation order, e.g. if imported from a WebVTT file, the cues in any given sample must be in the order they were in the WebVTT file.

When is recommended that the contents of the VTTCueBox boxes occur in the order shown in the syntax, but the order may not be mandatory.

When a cue has WebVTT Cue Settings, they are placed into a CueSettingsBox without the leading space that separates timing and settings.

When a WebVTT source label box is present in the sample entry and a cue is written into multiple samples, it must be represented in a set of VTTCueBoxes all containing the same source_ID. All VTTCueBoxes that originate from the same VTT cue must have the same source_ID, and that source_ID must be unique within the set of cues that share the same source_label. This means that when stepping from one sample to another (possibly after a seek, as well as during sequential play), a match of source_ID under the same source_label is diagnostic that the same cue is still active. Cues with no CueSourceIDBox are independent from all other cues; a source ID may be assigned to all cues.

When there is no WebVTT source label in the sample entry, there must be no CueSourceIDBox in the associated samples. In this way the presence of the WebVTT source label indicates whether source IDs are assigned to cues split over several samples, or not.

When a cue has internal timing values (e.g. WebVTT cue timestamp as defined in the WebVTT specification) then each VTTCueBox must contain a CueTimeBox which gives the VTT timestamp associated with the start time of sample. When the cue content of a sample is passed to a VTT renderer, timestamps within the cues in the sample must be interpreted relative to the time given in this box, or adjusted considering this time and the sample start time.

The CuePayloadBox must contain exactly one WebVTT Cue. Other text, such as WebVTT Comments are placed into VTTAdditionalText boxes.

The sample entry code is ‘vttC’; in contrast the VTTCueBox is ‘vttc’ and their container is also different.

In the CuePayloadBox there must be no blank lines (but there may be multiple lines).

aligned(8) class VTTCueBox extends Box(′vttc′) {

| | |
|---|---|
| CueSourceIDBox( ) | // optional source ID |
| CueIDBox( ); | // optional |
| CueTimeBox( ); | // optional current time indication |

CueSettingsBox( ); // optional, cue settings

| | |
|---|---|
| CuePayloadBox( ); | // the (mandatory) cue payload lines |

};
class CueSourceIDBox extends Box(‘vsid’) {

| | |
|---|---|
| int(32) source_ID; | // when absent, takes a special ‘always unique’ value |

}
class CueTimeBox extends Box(‘ctim’) {

| | |
|---|---|
| boxstring | cue_current_time; |

}
class CueIDBox extends Box(‘iden’) {

| | |
|---|---|
| boxstring | cue_id; |

}
class CueSettingsBox extends Box(‘sttg’) {

| | |
|---|---|
| boxstring | settings; |

}
class CuePayloadBox extends Box(‘payl’) {

| | |
|---|---|
| boxstring | cue_text; |

}
// These next two are peers to the VTTCueBox
aligned(8) class VTTEmptyCueBox extends Box(′vtte′) {
// currently no defined contents, box must be empty
};
class VTTAdditionalTextBox extends Box(‘vtta’) {

| | |
|---|---|
| boxstring | cue_additional_text; |

}

Free space boxes and unrecognized boxes in any sample, or within the VTTCueBox or VTTEmptyCueBox may be present and should be ignored.

Although ISO/IEC 14496-30 and 3GPP TS 26.245 defines carriage of timed text documents in ISOBMFF tracks and 3GPP file format they do not define carriage of text items. Text items may be used with images for annotations, providing cues, for memes, and the like. There is a need to define text items and provide a mechanism to associate them with the image items and/or with video tracks.

A text document is a file-based representation of textual content, possibly XML, used to produce text items.

A text item may be defined as an item whose data is a text document.

Alternatively, the text item may be defined as an item containing the data which when decoded results in textual content.

In an embodiment, an item with an item_type value of ‘text’ is a text item whose data may to be used in conjunction with other media such as an image item, audio track(s), video track(s), or other media types such as haptics track(s).

In an embodiment, a subtitle item is defined as a text item potentially also presenting an image item.

In an embodiment, an item with an item_type value of ‘subt’ is a subtitle item whose data may to be used in conjunction with other media such as an image item, audio track(s), video track(s), other media types such as haptics track(s).

In an embodiment, the text item is associated with the image item using an item reference, e.g. of type ‘cdsc’ from the text item to the image item. In an alternate embodiment any value of 4 cc can be used to define the item reference from the text item to an associated image item.

In an embodiment, the text item may have associated properties such as width, height indicating the 2D dimensions of the area within which a player or reader or the entity responsible for displaying/rendering is expected to display/render the text item.

In an embodiment, the text item may have associated properties such as position along the x and y directions. It is the position from which the which the text data contained in the text item is to be displayed/rendered by a player or reader or the entity responsible for displaying/rendering.

In an embodiment, the position of the text data contained in the text item to be displayed/rendered by a player, a reader, or an entity responsible for displaying/rendering is along a reference space with a defined reference x and reference y directions and a defined reference width and reference height.

In an alternate embodiment, the position of the text data contained in the text item to be displayed/rendered by a player or reader or the entity responsible for displaying/rendering is along the associated image item, the association may be defined using an item reference of a given type (for example, ‘cdsc’ or any other 4 cc value) from the text item to the image item. The position may be defined assuming that the x-axis direction is starting from top-left and running right till the width of the associated image item and the y-axis direction is starting from top-left and running down till the height of the associated image item.

In an embodiment, the text data contained in the text item may be not fit the display/rendering dimensions defined for the text item in such a case the text item may have associated properties such as scaling indicating to a player or reader or the entity responsible for displaying/rendering to scale the text data so that I fits within the defined display/rendering dimensions.

In an embodiment, a text item data structure may carry information of one or more text data that is to be displayed/rendered by a player or reader or the entity responsible for displaying/rendering.

In an embodiment, a text item may have associated properties such as language indicating the language of the text data contained in the text item.

In an embodiment, a text item may have associated properties such as direction indicating the direction along which the text data contained in the text item is to be displayed/rendered by a player or reader or the entity responsible for displaying/rendering. In an example embodiment, the direction can be from left to right, right to left, top to bottom, bottom to top.

Various embodiments provide necessary syntax elements for signaling and configuring text items and store them efficiently in media files, for example, HEIF files.

For efficient carriage of text items the TextItem data structure is introduced as follows.

```
Aligned(8) class TextItem{
  unsigned int (8) version = 0;
  unsigned int (8) flags;
  field_size = ((flags & 1) + 1) * 16;
  unsigned int(field_size) reference_width;
  unsigned int(field_size) reference_height;
  unsigned int(8) text_field_count;
    for (r=0; r < text_field_count; r++) {
    // rectangle
    // ISO-639-2/T language code
    unsigned int(5)[3] language;
    signed int(field_size) x;
    signed int(field_size) y;
    unsigned int(field_size) width;
    unsigned int(field_size) height;
    unsigned int (1) item_size_is_aspect_ratio;
    unsigned int (1) scaling;
    unsigned int (2) direction;
    bit (7) reserved = 0;
    unsigned int(8) text_coding_method;
    unsigned int(32) text_coding_parameters;
    bit(8) data[ ];
  }
}
```

The following semantics describes example syntax elements:
Version filed indicates a version of a box in the a media item or a file. In an instance there are any changes to the box structure in the future, the version field may be used to add new information be equal to 0.
(flags & 1) equal to 0 specifies that the length of the fields x, y, width, height, reference_width, reference_height is 16 bits. (flags & 1) equal to 1 specifies that the length of the fields x, y, width, height, reference_width, reference_height is 32 bits. The values of flags greater than 1 are reserved.reference_width, reference_height specify, in pixel units, the width and height, respectively, of the reference space on which the text items are placed.

The reference space may be defined as a 2D coordinate system with the origin (0,0) located at the top-left corner and a maximum size defined by reference_width and reference_height; the x-axis is oriented from left to right and the y-axis from top to bottom. The position of the text item inside the associated image item may be obtained after applying the implicit resampling caused by the difference between the size of the reference space and the size of the associated image item. In an instance the text item has transformative item properties, the implicit resampling may be performed on the text item before the first of its transformative item properties is applied.

text_field_count—specifies the number of text data present in the text item.

language—declares the language code for this media, as a packed three-character code defined in ISO 639-2. Each character is packed as the difference between its ASCII value and 0x60. Since the code is confined to being three lower-case letters, these values are strictly positive.

In an embodiment, text items may be marked with a suitable language, indicating the audience for whom the item is appropriate. In an example, where it is suitable for a single language, the value of language in TextItem must match that declared language. The value ‘mul’ may be used for a multi-lingual text.

x, y specify the top, left corner of the text item relatively to the reference space. The value (x=0, y=0) represents the position of the top-left pixel in the reference space.

In an example, negative values for the x or y fields enable to specify top-left corners that are outside the image. This may be useful for updating text items during the edition of an HEIF file.

width, height—fixed-point 16. These 16 values are item-dependent. For text and subtitle items, depending on the coding format, they may describe the suggested size of the rendering position in the reference area. For such items, the value 0x0 may also be used to indicate that the data may be rendered at any size, for example, no preferred size has been indicated and that the actual size may be determined by the external context or by reusing the width and height of another item. For such items, the flag item_size_is_aspect_ratio may also be used.

item_size_is_aspect_ratio—The value 1 indicates that the width and height fields are not expressed in pixel units. The values have the same units but these units are not specified. The values are only an indication of the desired aspect ratio. In an instance, the aspect ratios of this item and other related items are not identical, the respective positioning of the item is undefined, or defined by external contexts.

scaling equal to 1 indicates that when the content of the text item does not fit a region defined for the text item, a content of the text item needs to be scaled to fit the defined region.

direction equal to 0 indicates that the content of the text item needs to be rendered from left to right.

direction equal to 1 indicates that the content of the text item needs to be rendered from right to left.

direction equal to 2 indicates that the content of the text item needs to be rendered from top to bottom.

direction equal to 3 indicates that the content of the text item needs to be rendered from bottom to top.

text_coding_method indicates the coding method applied on the text contained in data. The following values are defined:
0: text is encoded as TTML document.
1: text is encoded as WebVTT document.
2: text is encoded using UTF-8
3: text is encoded using ASCII
4: text is encoded using Unicode
Other values are reserved.

In an embodiment, the text item related properties such as position, size, direction, language, reference with and height, content encoding method may be defined in an associated item property of type ‘subc’ or any other 4 cc value. The content of the text item only being the text data itself.

In an embodiment, a TTML text item is an item carrying TTML document, which may be a document that correspond to a specification based on TTML.

In an embodiment, for TTML text item the width and height provide the spatial extent of the root container, as defined in the TTML recommendation. Any ‘extent’ attribute declared on the ‘tt’ element in the contained TTML document shall match the text item width and height. When the ‘extent’ attribute is not declared on the ‘tt’ element in the contained TTML document, the text item width and height may be set to 0 or to any desired size. This is used when the document is authored in a resolution-independent manner (e.g. using percentage layout).

In an alternate embodiment, when a resolution-independent document has been authored to a specific aspect ratio (whether or not the aspect ratio is explicitly signalled in the document) the item_size_is_aspect_ratio flag may be used to signal the authored aspect ratio. In this case, the text item width and height shall be set to values that indicate the authored aspect ratio (e.g. 16 by 9).

In an embodiment, each TTML text item shall have an associated item property of type ‘ttmc’ with the example content as defined below.

```
aligned(8) TTMLTextConfiguration(‘ttmc’) {
  utf8list namespace;
  utf8list schema_location; // optional
  utf8list auxiliary_mime_types;
  // optional, required if auxiliary resources are present
}
```

namespace is one or more XML namespaces to which the text item documents conform. When used for metadata, this is needed for identifying its type, e.g. gBSD or AQoS [MPEG-21-7] and for decoding using XML aware encoding mechanisms such as BiM.
schema_location is zero or more URLs for XML schema(s) to which the text item document conforms. If there is one namespace and one schema, then this field shall be the URL of the one schema. If there is more than one namespace, then the syntax of this field shall adhere to that for xsi:schemaLocation attribute as defined by XML. When used for metadata, this is needed for decoding of the timed metadata by XML aware encoding mechanisms such as BiM.
auxiliary_mime_types indicates the media type of all auxiliary resources, such as images and fonts, if present, stored as subtitle items.
The namespace field shall be set to at least one unique namespace. It should be set to indicate the primary TTML-based namespace of the document, and should be set to all namespaces in use in the document (e.g. TTML+TTML-Styling+SMPTE-TT),
The schema_location field should be set to schema pathnames that uniquely identify the profile or constraint set of the namespaces included in the namespace field.

In an embodiment, essential shall be equal to 1 for a ‘ttmc’ item property associated with an TTML text item.

In an embodiment, a WebVTT text content in items is encoded using UTF-8, and the data-type boxstring indicates an array of UTF-8 bytes, to fill the enclosing box, with neither a leading character count nor a trailing null terminator.

In an embodiment, each WebVTT cue, as defined in the WebVTT specification, is stored de-constructed, partly to emphasize that the textual timestamps one would normally find in a WebVTT file do not determine presentation timing; the ISO file structures do. It also separates the text of the actual cue from the structural information that the WebVTT file carries (positioning, timing, and so on). WebVTT cues are stored in a typical ISO boxed structured approach to enable interfacing an ISO file reader with a WebVTT renderer without the need to serialize the sample content as WebVTT text and to parse it again.

In an embodiment, WebVTT item properties or related structures shall not contain trailing CR or LF characters, or trailing CRLF sequences (where ‘trailing’ means that they occur last in the payload of the item property or related structures).

In an embodiment, each WebVTT cue shall be passed to the WebVTT renderer.

In an embodiment, there shall be no internal timing value in a WebVTT cue. If there is internal timing value in a WebVTT cue it shall be ignored.

In an embodiment, each WebVTT text item shall have a associated item property of type ‘wvtc’ called the WebVTT configuration item property with the example content as defined below.

| aligned(8) WebVTTTextConfiguration(‘wvtc’) { | |
|---|---|
| boxstring | config; |
| boxstring | source_label; |

}

In an embodiment, the WebVTT configuration item property shall carry exactly the lines of the WebVTT file header, i.e. all text lines up to but excluding the ‘two or more line terminators’ that end the header.

In an embodiment, the source_label is a suitable string identifier of the ‘source’ of this WebVTT content, such that if a file is made by editing together two pieces of content, the text items would need two entries because this source label differs. A URI is recommended for the source label; however, the URI is not interpreted, and it is not required there be a resource at the indicated location when a URL form is used.

In an embodiment, the character replacements as specified in step 1 of the WebVTT parsing algorithm, may be applied before VTT data is stored in this format. Image file readers with support for WebVTT text item should be prepared to apply these replacements if integrated directly with a WebVTT renderer.

In an embodiment, a WebVTT text item may have additional associated item properties as defined below.

In an embodiment, a WebVTT text item may have associated item property of type ‘vtte’ called the VTT Empty Cue item property in which there is no cue data

| aligned(8) VTTEmptyCue(‘vtte’) { | |
|---|---|
| boxstring | config; |
| boxstring | source_label; |

}

In an embodiment, a WebVTT text item may have associated item property of type “vsid” called the CueSourceID item property.

```
aligned(8) CueSourceID (′vsid′) {
  int(32) source_ID;  // when absent, takes a special ′always unique′
  value
}
```

A source_ID is generated for each cue, and placed into the WebVTT text item. All VTT Cues that originate from the same VTT cue must have the same source_ID, and that source_ID must be unique within the set of cues that share the same source_label.

In an embodiment, a WebVTT text item may have associated item property of type ‘iden’ called the CueID item property.

aligned(8) CueID (‘iden’) {

| | |
|---|---|
| boxstring | cue_id; |

}

| | |
|---|---|
| - | The WebVTT Cue Identifier, if it exists, is placed in a CueID |

In an embodiment, a WebVTT text item may have associated item property of type “sttg” called the CueSettings item property.

aligned(8) CueSettings (′sttg′) {
boxstring settings;
}

The WebVTT Cue Settings, if they exist, are placed into a CueSettings. If a cue has WebVTT Cue Settings, they are placed into a CueSetting item property without the leading space that separates timing and settings.

In an embodiment, a WebVTT text item may have associated item property of type ‘payl’ called the CuePayload item property.

| aligned(8) CuePayload (‘payl’) { | |
|---|---|
| boxstring | cue_text; |

}

The Cue Payload, without the following two or more line terminators, is placed into the CuePayload. The CuePayload item property must contact exactly one WebVTT Cue. Other text, such as WebVTT Comments are placed into VTTAdditionalText item property.

In an embodiment, a WevVTT text item may have associated item property of type “vtta” called the VTTAdditionalText item property.

aligned(8) VTTAdditionalText (′vtta′) {
boxstring cue_additional_text;
}

Each WebVTT Comment is placed in a VTTAdditionalText item property.

text_coding_parameters indicate additional encoding parameters needed for successfully processing the text data.

The data includes the coded representation of the text.

In an embodiment, a mime type item is defined. In an embodiment, the mime media type may be any of the renderable text, for example, plain text, html, webvtt, ttml, and the like. In an embodiment, the renderable text may be encoded with a known content coding method such as utf8, ascii, html, webvtt, ttml, or support vector graphics.

In an embodiment, a renderable item and/or a renderable item property is defined. The renderable item or item property carries the information required to render the mime type item defined above on a canvas or a background media such as an image or video. The information may include, but not limited to, the following parameters:
the language of the text to be rendered;
the location of the renderable text on a canvas or a background media, such as an image or video. The location may be signalled using, for example, the horizontal and vertical offset from the top-left corner of the said canvas or a background media such as an image or video;
the width and height of the renderable text; and/or
the direction of the renderable text, for example, some textual content may need to be rendered from left to right while some other textual content need to be rendered from right to left.

### Common Layout Behavior

The common layout behavior for processing of text item or a subtitle item is defined below.

In an embodiment, unless specified by an embedding environment (e.g. an HTML page), the TextItem information (e.g., width, height) may be used to size the subtitle item or text item content with respect to the associated items(s) as follows:
when the flag item_size_is_aspect_ratio is not set, and the item width and height are set to values different from 0; the size of the text item shall be the width and height as specified in TextItem.
when the flag item_size_is_aspect_ratio is not set, and the item width and height are set to 0, the size of the text item shall match the reference size.
when one item (for example an image item) is associated with the text item, the reference size is the size of the associated item. When multiple items are associated with the text item and/or when the multiple items are alternate to each other, the reference size is the size of an item which the player or reader choses for display/rendering.
when the flag item_size_is_aspect_ratio is set, it indicates that the content of the item was authored to an aspect ratio equal to the ration of width/height. In this case, neither width nor height shall be 0. The text item shall be sized to the maximum size that will fit within the reference size and should be equal the width or height of the item, while preserving the indicated aspect ratio.
   Associating Text Items with Image Items

Text items may be associated explicitly or implicitly with other items in the file.

In an embodiment, the text items are explicitly associated with an image item using an item reference of type ‘subt’ to that image item.

When no ‘subt’ item reference is used, the text item is said to be implicitly associated to all items in the file.

In an alternate embodiment, a text item may be defined as an item whose data defines the size, position, direction, language and the textual data to be displayed/rendered on the image item with which it is associated via an item reference.

According to the alternate embodiment, an item with an item_type value of ‘txti’ is a text item that defines textual data of an image.

In an embodiment, the text item is associated with the image item on which the textual data is displayed/rendered using an item reference of type ‘cdsc’ from the text item to the image item.

In an embodiment, the data of the text item define the size, position, direction, language and the textual data to be displayed/rendered on the associated image item. The size, position and direction information are used to display/render the textual data inside a reference space that is mapped to the image item with which the text item is associated after any transformative item property is applied to the image item.

In an embodiment, the reference space is defined as a 2D coordinate system with the origin (0,0) located at the top-left corner and a maximum size defined by reference_width and reference_height; the x-axis is oriented from left to right and the y-axis from top to bottom. The placement of textual data inside the associated image item is obtained after applying the implicit resampling caused by the difference between the size of the reference space and the size of the associated image item. If the text item has transformative item properties, then the implicit resampling shall be performed on the text item before the first of its transformative item properties is applied.

Various embodiments provide necessary syntax elements for signaling and configuring text items and store them efficiently in a media files, for example, HEIF files.

For efficient carriage of text items the alternative TextItem data structure is introduced as follows.

```
aligned(8) class TextItem{
  unsigned int (8) version = 0;
  unsigned int (8) flags;
  field_size = ((flags & 1) + 1) * 16;
  unsigned int(field_size) reference_width;
  unsigned int(field_size) reference_height;
  signed int(field_size) x;
  signed int(field_size) y;
  unsigned int(field_size) width;
  unsigned int(field_size) height;
  unsigned int (2) direction;
  utf8string language;
  bit (6) reserved = 0;
  utf8string text;
}
version shall be equal to 0.
```

(flags & 1) equal to 0 specifies that the length of the fields x, y, width, height is 16 bits. (flags & 1) equal to 1 specifies that the length of the fields x, y, width, height is 32 bits. The values of flags greater than 1 are reserved.

reference_width, reference_height specify, in pixel units, the width and height, respectively, of the reference space on which the text items are placed.

x, y specify the top, left corner of the text item relatively to the reference space. The value (x=0, y=0) represents the position of the top-left pixel in the reference space.

In an example, negative values for the x or y fields enable to specify top-left corners that are outside the image. This can be useful for updating text items during the edition of an HEIF file.

width, height—fixed-point 16.16 values are item-dependent as follows. For text and subtitle items, they may, depending on the coding format, describe the suggested size of the rendering area. For such items, the value 0x0 may also be used to indicate that the data may be rendered at any size, that no preferred size has been indicated and that the actual size may be determined by the external context or by reusing the width and height of another item. For those items, the flag item_size_is_aspect_ratio may also be used.

direction equal to 0 indicates that the content of the text item needs to be rendered from left to right. direction equal to 1 indicates that the content of the text item needs to be rendered from right to left

direction equal to 2 indicates that the content of the text item needs to be rendered from top to bottom

direction equal to 3 indicates that the content of the text item needs to be rendered from bottom to top

language is a character string containing an RFC 5646 compliant language tag string, such as “en-US”, “fr-FR”, or “zh-CN”, representing the language of the text. When language is empty, the language is unknown/undefined.

text is a character string. When not present (an empty string is supplied) no textual data is provided.

In an embodiment, an entity if when parsing the textual data contained in the text item does not understand or recognize the characters or the coding format of the textual data or there is an error while parsing the textual data shall not display any textual data and gracefully handle (for example by hiding)/ignore the textual content. In an example embodiment, neither a glyph is shown nor is the current rendering position changed.

In an embodiment, the text item data structure may additionally indicate the fonts to be used for the rendering/display of the textual data.

In an alternate embodiment, a new item may defined called an font item of type ‘font’ which carries the fonts used for the rendering of the associated text item. The font item and the text item may be associated with item reference of type ‘tfon’ from the text item to the font item.

In an embodiment, fonts not supplied with the content may be already present on the target system(s), or supplied using any suitable supported mechanism (e.g. font streaming as defined in ISO/IEC 14496-18).

In an alternate embodiment, fonts may be defined by name, size, and style. In an embodiment, if the reader/player requested to render a character where the specified font does not support that character should substitute a suitable font.

In an embodiment, the size of the font may defined in pixel units or as percentage of the rendering area defined in the text item data structure.

| aligned FontRecord { | |
|---|---|
| unsigned int(16) | font-ID; |
| unsigned int(8) | font-name-length; |
| unsigned int(8) | font[font-name-length]; |

}

A font table shall follow these fields, to define the complete set of fonts used. Every font used in the text data is defined here by name. Each entry consists of a 16-bit local font identifier, and a font name, expressed as a string, preceded by an 8-bit field giving the length of the string in bytes. The name is expressed in UTF-8 characters, unless preceded by a UTF-16 byte-order-mark, whereupon the rest of the string is in 16-bit Unicode characters. The string should be a comma separated list of font names to be used as alternative font, in preference order. The special names “Serif”, “Sans-serif” and “Monospace” may be used.

In an embodiment, the font may be associated with/specified by style properties such as bold, italic (oblique) and bold-italic.

In an embodiment, the colour of both textual data and the background color of the text data are indicated using RGB values.

In an embodiment, the colours may also have an alpha or transparency value associated with them. In an example embodiment, a transparency value of 0 indicates a fully transparent colour, and a value of 255 indicates fully opaque.

| aligned(8) class FontStyleRecord (‘fsty’) { | |
|---|---|
| unsigned int(16) | startChar; |
| unsigned int(16) | endChar; |
| unsigned int(16) | font-ID; |
| unsigned int(8) | face-style-flags; |
| unsigned int(8) | font-size; |
| unsigned int(8) | text-color-rgba[4]; |
| } | |

startChar: character offset of the beginning of this style run (always 0 in a sample description).

endChar: first character offset to which this style does not apply (always 0 in a sample description); shall be greater than or equal to startChar. All characters, including line-break characters and any other non-printing characters, are included in the character counts.

font-ID: font identifier from the font table; in a sample description, this is the default font.

face style flags: where value of ‘1’ indicates ‘bold’, value of ‘2’ indicates ‘italic’, and value of ‘4’ indicates ‘underline’. In the absence of any bits set, the text is plain.

font-size: font size (nominal pixel size, in essentially the same units as the width and height)

text-color-rgba: rgb colour, 8 bits each of red, green, blue, and an alpha (transparency) value

In an embodiment, the text item may specify wrapping of text from line to line. Text wrap behavior may be specified using an associated TextWrap item property

| aligned(8) TextWrap (‘twrp’) { | |
|---|---|
| unsigned int(8) | wrap_flag; |

}

wrap_flag: may take any of the following values
0x00 No wrap
0x01 Automatic ‘soft’ wrap enabled
0x02-0xFF Reserved

In an embodiment, a text item may be associated with an item property of type ‘blnk’ called the blink item property to indicate the blinking of the text item.

This requests blinking text for the indicated character range of the charaters defined as part of the data within the text item.

| aligned Blink (‘blnk’) { | |
|---|---|
| unsigned int(16) | startcharoffset; |
| unsigned int(16) | endcharoffset; |

}

startCharOffset:—the start offset of the text to be linked.

endCharOffset:—the end offset of the text (start offset+number of characters)

In an embodiment, a text item may associate all of any of the following with the textual data, descriptive image properties, using the ItemPropertyAssociationBox.

In an example embodiment, a text item may be associated with a UserDescriptionProperty to associate a description/tags with a text item associated with an image item.

In an embodiment, metadata items may be associated with text items, using an item reference of type ‘cdsc’ from the metadata item to the text item.

In an embodiment, an item is a derived text item, when it includes a ‘dsub’ item reference to one or more other text items, which are inputs to the derivation. The reference space and textual data defined by a derived text item are obtained by applying the operation of the derived text item to the reference space and textual data of the input text items of the derived text item. The exact operation performed to obtain the reference space and the textual data is identified by the item_type of the item.

In an embodiment, transformative item properties associated with a derived text item may apply to the reference space and textual data defined by the derived text item before they are applied to the image item referenced by the derived text item with an item reference of type, e.g., ‘cdsc’.

In an embodiment, the number of SingleItemTypeReferenceBoxes with the box type ‘dsub’ or ‘dtit’ and with the same value of from_item_ID shall not be greater than 1.

In an embodiment, a derived text item of the item_type value ‘iovl’ (overlay) may be used when it is desired to overlay one or more text items in a given layering order within a large canvas. The input text items are listed in the order they are layered i.e. the bottom-most input text item first and the top-most input text item last, in the SingleItemTypeReferenceBox of type ‘dtit’ for this derived text item within the ItemReferenceBox.

In an embodiment, file writers need to be careful when removing an text item that is marked as an input text item of an text overlay item, as the content of the text overlay item might need to be rewritten.

In an alternate embodiment, an entity to group box of grouping_type ‘tilg’ (text item layering order group) may be defined to indicate the layering order to be used for displaying/rendering. the entity group may list only the text items to be layered on the associated image item or the entity group may list all the text items together with the associated media track or item on which the textual data is to be displayed/rendered. The input text items and the associated media tems are listed in the order they are layered. With the item having entity_id equal to 0 as the bottom most and the other items layered with increasing values of entity_id.

### Using MIME Type Item

In an embodiment, a mime type item is defined for renderable text. An item with an item_type value of ‘mime’ is a mime type item. The data in the mime type item is a renderable text for example ‘html’ or ‘plain text’. The content_type in ItemInfoEntry of the ItemInfoBox is set equal to the MIME type of the data in the mime type item. Examples for this field may include ‘text/html’ and ‘text/plain’.

In an embodiment, the content_type may be any of the following types:
text/html;
text/plain;
text/richtext;
text/enriched;
text/vtt, text/xml;
image/svg+xml; or
any of the mime sub-types listed at https://iana.org/assignments/media-types/media-types.xhtml#text (last accessed Dec. 8, 2021).

In an embodiment, the renderable text may be further encoded with either gzip, deflate, compress, algorithm, or any other alogithm defined for content-encoding of Http/1.1. The encoding of renderable text is defined by the content_encoding parameter in ItemInfoEntry of the ItemInfoBox.

In an embodiment, when the renderable text is encoded with any of the alogithm defined for content-encoding of Http/1.1, the data needs to be decoded before interpreting it as the mime type identified by the content_type in ItemInfoEntry of the ItemInfoBox.

When the content_encoding parameter in ItemInfoEntry of the ItemInfoBox has an empty string it indicates that no content encoding was applied on the renderable text. In another embodiment, an empty string may be replaced by a pre-defined known string character ‘r’ in order to indicate no content encoding.

The mime type item of renderable text carries the text data required for rendering, however, it does not provide any information on the display conditions for example the position, size and direction of the renderable text.

### Renderable Item

In an embodiment, a renderable item is defined. The renderable item provides the information for the text layout and the terms can be used interchangeably throughout the document. An item with an item_type value or ‘rdit’ is a renderable item. The 4 cc value of ‘rdit’ is an example any other valid 4 cc value may be used. The renderable item carries the information required to render the text on to an image item.

An example syntax and semantics of the renderable item is given below.

### Syntax

```
aligned(8) class RenderableItem{
  unsigned int (8) version = 0;
  unsigned int (8) flags;
  field_size = ((flags & 1) + 1) * 16;
  unsigned int(field_size) reference_width;
  unsigned int(field_size) reference_height;
  signed int(field_size) x;
  signed int(field_size) y;
  unsigned int(field_size) width;
  unsigned int(field_size) height;
    unsigned int (2) direction;
    utf8string language;
  bit (6) reserved = 0;
  utf8string text;
}
```

### Semantics

version shall be equal to 0.

(flags & 1) equal to 0 specifies that the length of the fields x, y, width, height is 16 bits. (flags & 1) equal to 1 specifies that the length of the fields x, y, width, height is 32 bits. The values of flags greater than 1 are reserved.

reference_width, reference_height specify, in pixel units, the width and height, respectively, of the reference space on which the text items are placed.

x, y specify the top, left corner of the text item relatively to the reference space. The value (x=0, y=0) represents the position of the top-left pixel in the reference space.

In an example, negative values for the x or y fields enable to specify top-left corners that are outside the image. This can be useful for updating text items during the edition of an HEIF file.

width, height—fixed-point 16. 16 values are item-dependent as follows: for text and subtitle items, they may, depending on the coding format, describe the suggested size of the rendering area. For such items, the value 0x0 may also be used to indicate that the data may be rendered at any size, that no preferred size has been indicated and that the actual size may be determined by the external context or by reusing the width and height of another item. For those items, the flag item_size_is_aspect_ratio may also be used.

direction equal to 0 indicates that the content of the text item needs to be rendered from left to right. direction equal to 1 indicates that the content of the text item needs to be rendered from right to left

direction equal to 2 indicates that the content of the text item needs to be rendered from top to bottom

direction equal to 3 indicates that the content of the text item needs to be rendered from bottom to top

language is a character string containing an RFC 5646 compliant language tag string, such as ‘en-US’, ‘fr-FR’, or ‘zh-CN’, representing the language of the text. When language is empty, the language is unknown/undefined.

text is a character string. When not present (an empty string is supplied) no textual data is provided.

The region item is associated with the mime type item using an item reference of type ‘cdsc’ or another similar 4-character-code from the renderable item to the mime type item. In another embodiment, the link between the item and mime item type may be in the other direction (from mime item type towards the renderable item)

### Text Layout as an Item Property

The rendering information for the mime type item with renderable text may be defined as part of the descriptive item property or the transformative item property of the associated mime type item with renderable text.

### Text Layout Information

### Definition

Box type: ‘txlo’
Property type: Descriptive or transformative item property
Container: ItemPropertyContainerBox
Mandatory (per item): No
Quantity (per item): One or more

The TextLayoutProperty documents provides the rendering layout information of the associated mime type item with renderable text. Every image item shall be associated with one property of this type, prior to the association of all transformative properties.

### Syntax

```
aligned(8) class TextLayoutProperty
extends ItemFullProperty(‘txlo’, version = 0, flags = 0) {
    unsigned int (8) flags;
    field_size = ((flags & 1) + 1) * 16;
    unsigned int(field_size) reference_width;
    unsigned int(field_size) reference_height;
    signed int(field_size) x;
    signed int(field_size) y;
    unsigned int(field_size) width;
    unsigned int(field_size) height;
  unsigned int (2) direction;
  utf8stringlanguage;
  bit (6) reserved = 0;
}
```

### Semantics

(flags & 1) equal to 0 specifies that the length of the fields x, y, width, height is 16 bits. (flags & 1) equal to 1 specifies that the length of the fields x, y, width, height is 32 bits. The values of flags greater than 1 are reserved.

reference_width, reference_height specify, in pixel units, the width and height, respectively, of the reference space on which the text items are placed.

x, y specify the top, left corner of the text item relatively to the reference space. The value (x=0, y=0) represents the position of the top-left pixel in the reference space.

In an example, negative values for the x or y fields enable to specify top-left corners that are outside the image. This can be useful for updating text items during an editing operation of an HEIF file.

width, height—fixed-point 16. 16 values are item-dependent as follows. For text and subtitle items, they may, depending on the coding format, describe the suggested size of the rendering area. For such items, the value 0x0 may also be used to indicate that the data may be rendered at any size, that no preferred size has been indicated and that the actual size may be determined by the external context or by reusing the width and height of another item. For those items, the flag item_size_is_aspect_ratio may also be used.

direction equal to 0 indicates that the content of the text item needs to be rendered from left to right. direction equal to 1 indicates that the content of the text item needs to be rendered from right to left.

direction equal to 2 indicates that the content of the text item needs to be rendered from top to bottom

direction equal to 3 indicates that the content of the text item needs to be rendered from bottom to top.

language is a character string containing an RFC 5646 compliant language tag string, such as ‘en-US’, ‘fr-FR’, or ‘zh-CN’, representing the language of the text. When language is empty, the language is unknown/undefined.

### Derivation of a Renderable Text of a Text Item

The reconstructed renderable text of a text item or a mime type item (where the data in the mime type item is a renderable text) may be derived as follows:
when the text item or a mime type item (where the data in the mime type item is a renderable text) contains a renderable text, the renderable text is decoded and the reconstructed renderable text is the output of the decoding process specified for the content_type in ItemInfoEntry of the ItemInfoBox of the text item or a mime type item (where the data in the mime type item is a renderable text);
when the text item or a mime type item is a derived text item or a derived mime type item (where the data in the mime type item is a renderable text), the operation of the derived text item or a derived mime type item (where the data in the mime type item is a renderable text) is applied to the input of the derived text item or a derived mime type item (where the data in the mime type item is a renderable text) to form the reconstructed renderable text.

The output renderable text of a text item or a mime type item (where the data in the mime type item is a renderable text) is derived from the reconstructed renderable text of the text item or a mime type item (where the data in the mime type item is a renderable text) as follows:
when the text item or a mime type item (where the data in the mime type item is a renderable text) has no transformative item properties, the output renderable text is identical to the reconstructed renderable text;
when the text item a mime type item has transformative item properties, the following applies: A sequence of transformative item properties is formed from the following:
a) all essential transformative item properties of the text item or a mime type item (where the data in the mime type item is a renderable text) and
b) any set of the non-essential transformative item properties of the text item or a mime type item (where the data in the mime type item is a renderable text).
The said sequence of transformative item properties is applied, in the order of their appearance in the ItemPropertyAssociation for the text item or a mime type item (where the data in the mime type item is a renderable text), to the reconstructed renderable text to obtain the output renderable text.

### Alternate Ways of Specifying Renderable Text

### Define Roles for an Item

In an embodiment, the renderable text may be a coded image or a derived image authored into an image item. In an embodiment, the image item carrying the coded or derived renderable text is indicated with a qualifier such as subtitle image item or a caption image item or an overlay image item or a text image item.

In an alternate embodiment, a text item or a mime type item (where the data in the mime type item is a renderable text) is indicated with a qualifier such as subtitle text item, subtitle mime type item, a caption text item, caption mime type item, an overlay text item, or an overlay mime type item.

In an embodiment, a subtitle image item, a caption image item, an overlay image item, a text image item, a subtitle text item, subtitle mime type item, a caption text item, a caption mime type item, an overlay text item, an overlay mime type item is linked with an image item on which the text is to be rendered using a reference type ‘subt’ or ‘capt’ from the item containing the rendereable text to the image item on which the text is to be rendered.

### Using Relative Location to Define Text Layout

In an embodiment, the position of the renderable text on the related image item may be defined using the RelativeLocationProperty descriptive item property. In an embodiment, the RelativeLocationProperty descriptive item property is used to describe the horizontal and vertical position of the (subtitle image item, a caption image item, an overlay image item, a text image item, a subtitle text item, a subtitle mime type item, a caption text item, a caption mime type item, an overlay text item, or an overlay mime type item) item containing the renderable text relative to the reconstructed image of the related image item identified through the ‘tbas’ item reference as specified below. In an embodiment, the pixel sampling of the item containing the renderable text may be identical or substantially identical to that of the related image item. In an embodiment, the sampling grids of the item containing the renderable text and the related image item may be aligned (e.g., not have a sub-pixel offset). Consequently, one pixel in the item containing the renderable text collocates to exactly one pixel in the related image item. In an embodiment, the related image item may be identified by an item reference of type ‘tbas’ from the item containing the renderable text to the related image item. In an embodiment, an item reference of type ‘tbas’ from the item containing the renderable text to the related image item may be present in addition to an item reference of type ‘subt’ or ‘capt’ from the item containing the renderable text to the related image item. In an alternate embodiment an item reference of type ‘tbas’ from the item containing the renderable text to the related image item.

In an embodiment, the horizontal_offset in the RelativeLocationProperty specifies the horizontal offset in pixels of the left-most pixel column of the item containing the renderable text to the reconstructed image of the related image item. The left-most pixel column of the reconstructed image of the related image item has a horizontal offset equal to 0.

In an embodiment, the vertical_offset specifies the vertical offset in pixels of the top-most pixel row of the item containing the renderable text to the reconstructed image of the related image item. The top-most pixel row of the reconstructed image of the related image item has a vertical offset equal to 0.

### Define EntityToGroupBox for Alternative Grouping

In an embodiment, an entitytogroupbox extension may be defined called the subtitleAlternateBox which groups all the items containing renderable text which are alternate of each other. In an embodiment, any one member of the subtitleAlternateBox may be used for rendering the text on the related image item. In an example embodiment, one of the criteria to group items containing renderable text is that the content of the text is in different languages.

### Visual Media Overlay Derivation

In an embodiment, an item with any visual media (for example, renderable text) overlay derivation is defined.

In an embodiment, a visual media may be an image, renderable text, a static volumetric media or any other visual media which could be visualized on a canvas.

In an embodiment, an item with an item_type value of ‘vovl’ defines a derived visual media item by overlaying one or more visual media in a given layering order within a larger canvas. The input visual media are listed in the order they are layered, i.e. the bottom-most input visual media first and the top-most input visual media last, in the SingleItemTypeReferenceBox of type ‘ditm’ for this derived visual media item within the ItemReferenceBox.

In an embodiment, file writers need to be careful when removing an item that is marked as an input visual media of a visual media overlay item, as the content of the visual media overlay item might need to be rewritten.

In an example embodiment, the syntax of visual media overlay is defined below:

```
aligned(8) class VisualMediaOverlay {
  unsigned int(8) version = 0;
  unsigned int(8) flags;
  for (j=0; j<4; j++) {
    unsigned int(16) canvas_fill_value;
  }
  unsigned int FieldLength = ((flags & 1) + 1) * 16; // this is a temporary, non-parsable
variable
  unsigned int(FieldLength) output_width;
  unsigned int(FieldLength) output_height;
  for (i=0; i<reference_count; i++) {
    signed int(FieldLength) horizontal_offset;
    signed int(FieldLength) vertical_offset;
  }
}
```

In an example embodiment, the semantics of the fields in the VisualMediaOverlay struct is defined below:

version shall be equal to 0.

(flags & 1) equal to 0 specifies that the length of the fields output_width, output_height, horizontal_offset, and vertical_offset is 16 bits. (flags & 1) equal to 1 specifies that the length of the fields output_width, output_height, horizontal_offset, and vertical_offset is 32 bits. The values of flags greater than 1 are reserved.

canvas_fill_value: indicates the pixel value per channels used when no pixel of any input image is located at a particular pixel location. The fill values are specified as RGBA (R, G, B, and A corresponding to loop counter j equal to 0, 1, 2, and 3, respectively). The RGB values are in the sRGB color space as defined in IEC 61966-2-1. The A value is a linear opacity value ranging from 0 (fully transparent) to 65535 (fully opaque).

output_width, output_height: Specify the width and height, respectively, of the reconstructed visual media on which the input visual media are placed. The visual media area of the reconstructed visual media is referred to as the canvas.

reference_count is obtained from the SingleItemTypeReferenceBox of type ‘ditm’ where this item is identified by the from_item_ID field.

horizontal_offset, vertical_offset: Specifies the offset, from the top-left corner of the canvas, to which the input visual media is located. Pixel locations with a negative offset value are not included in the reconstructed visual media. Horizontal pixel locations greater than or equal to output_width are not included in the reconstructed visual media. Vertical pixel locations greater than or equal to output_height are not included in the reconstructed visual media.

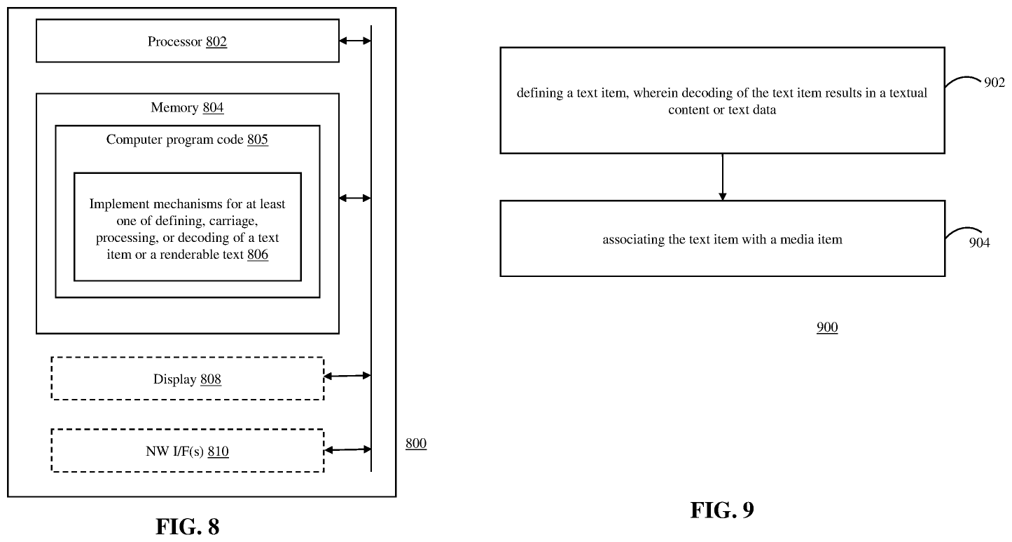

FIG. 8 is an example apparatus 800, which may be implemented in hardware, configured to implement mechanisms for at least one of defining, carriage or processing of renderable text, based on the examples described herein. The apparatus 800 comprises at least one processor 802, at least one non-transitory memory 804 including computer program code 805, wherein the at least one memory 804 and the computer program code 805 are configured to, with the at least one processor 802, cause the apparatus 800 to implement mechanisms for, at least one of, defining, carriage, processing, or decoding of renderable text 806, based on the examples described herein. In some examples, the text item may be used with media items for providing annotations, cues, memes, and the like. Some example of media items, includes, but are not limited to, images, audio tracks, video tracks, haptic tracks, video games, and the like.

The apparatus 800 optionally includes a display 808 that may be used to display content during rendering. The apparatus 800 optionally includes one or more network (NW) interfaces (I/F(s)) 810. The NW I/F(s) 810 may be wired and/or wireless and communicate over the Internet/other network(s) via any communication technique. The NW I/F(s) 810 may comprise one or more transmitters and one or more receivers. The N/W I/F(s) 810 may comprise standard well-known components such as an amplifier, filter, frequency-converter, (de)modulator, and encoder/decoder circuitry(ies) and one or more antennas.

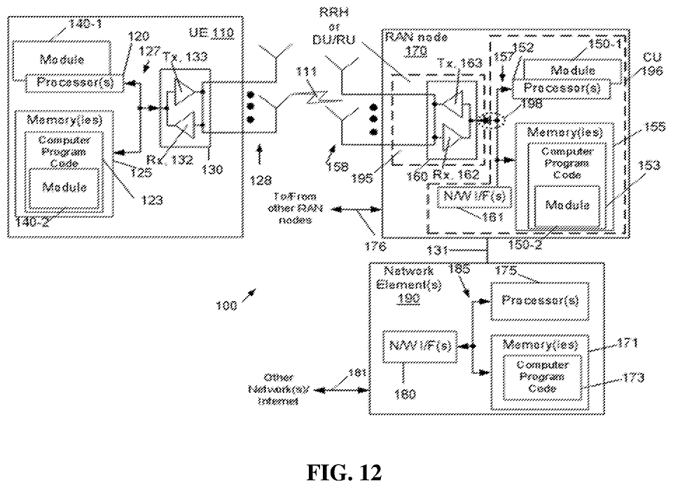

The apparatus 800 may be a remote, virtual or cloud apparatus. The apparatus 800 may be either a coder or a decoder, or both a coder and a decoder. The at least one memory 804 may be implemented using any suitable data storage technology, such as semiconductor based memory devices, flash memory, magnetic memory devices and systems, optical memory devices and systems, fixed memory and removable memory. The at least one memory 804 may comprise a database for storing data. The apparatus 800 need not comprise each of the features mentioned, or may comprise other features as well. The apparatus 800 may correspond to or be another embodiment of the apparatus 50 shown in FIG. 1 and FIG. 2, or any of the apparatuses shown in FIG. 3. The apparatus 800 may correspond to or be another embodiment of the apparatuses shown in FIG. 12, including UE 110, RAN node 170, or network element(s) 190.

FIG. 9 illustrates an example method 900 for implementing mechanisms for defining a text item, in accordance with an embodiment. As shown in block 806 of FIG. 8, the apparatus 800 includes means, such as the processing circuitry 802 or the like, to implement mechanisms for defining a text item. At 902, the method 900 includes defining a text item, wherein decoding of the text item results in a textual content or text data.

In an embodiment, defining includes defining a text item data structure comprising one or more of the following: a reference width field for specifying a width of a reference space on which the textual content or text data is placed; a reference height field for specifying a height of the reference space on which the textual content or text data is placed; a language field for declaring a language code associated with the media item; x and y fields for specifying a top, left corner of the text item relatively to the reference space, and wherein a value x=0 and y=0 represents a position of a top-left pixel in the reference space; width and height fields for the textual content or text data describes a size of a rendering position in the reference area; a flag for indicting at least one of a length of the fields x, y, the width, the height, the reference height, or the reference height; or a direction field for indicating a direction in which the content of the text item needs to be rendered.

In an embodiment, the text item data structure further includes at least one of following: a version field indicating a version of a box in the media item or a file; a text field count for specifying a number of the textual content or the text data present in the text item; an aspect ratio field for indicating an aspect ratio between a width indicated by the width field and a height indicated by the height field; a scaling field for indicating the content of the text item does not fit a region defined for the text item and the content of the text item needs to be scaled to fit in the defined region; a text coding method field for indicating a coding method applied on the text item; text coding parameters for indicating additional encoding parameters needed for processing the textual data or the text data; a data field for storing the textual data or the text data; or a text field comprising a character string.

At 904, the method 900 includes associating the text item with a media item. Some examples of the media item include, but are not limited to, images, audio tracks, video tracks, haptic tracks, video games, and the like.

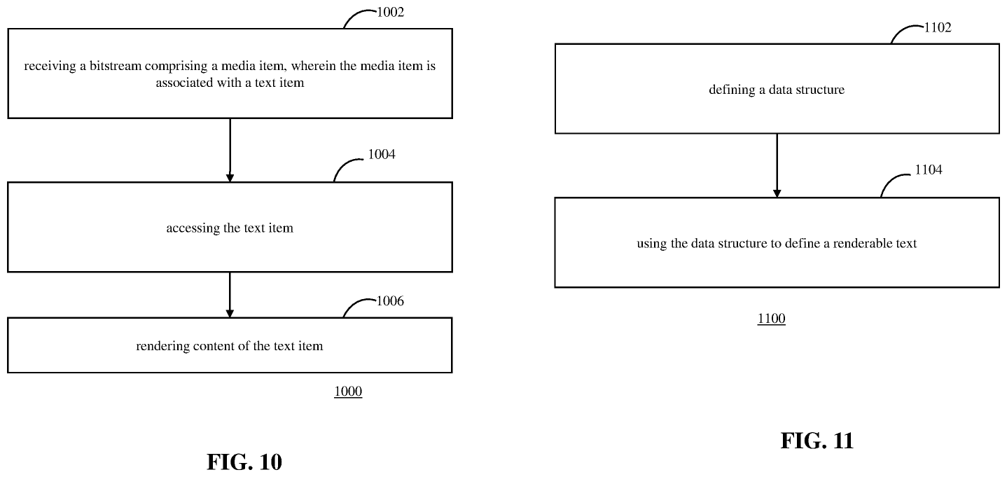

FIG. 10 illustrates an example method 1000 for implementing mechanisms for processing of a text item, in accordance with an embodiment. As shown in block 806 of FIG. 8, the apparatus 800 includes means, such as the processing circuitry 802 or the like, to implement mechanisms for processing of the text item. At 1002, the method 1000 includes receiving a bitstream comprising a media item, wherein the media item is associated with a text item.

In an embodiment, the text item is defined by using a text item data structure includes one or more of the following: a reference width field for specifying a width of a reference space on which the textual content or text data is placed; a reference height field for specifying a height of the reference space on which the textual content or text data is placed; a language field for declaring a language code associated with the media item; x and y fields for specifying a top, left corner of the text item relatively to the reference space, and wherein a value x=0 and y=0 represents a position of a top-left pixel in the reference space; width and height fields for the textual content or text data describes a size of a rendering position in the reference area; a flag for indicting at least one of a length of the fields x, y, the width, the height, the reference height, or the reference width; or a direction field for indicating a direction in which the content of the text item needs to be rendered.

In an embodiment, the text item data structure may further include at least one of following: a version field indicating a version of a box in the media item or a file; a text field count for specifying a number of the textual content or the text data present in the text item; an aspect ratio field for indicating an aspect ratio between a width indicated by the width field and a height indicated by the height field; a scaling field for indicating the content of the text item does not fit a region defined for the text item and the content of the text item needs to be scaled to fit in the defined region; a text coding method field for indicating a coding method applied on the text item; text coding parameters for indicating additional encoding parameters needed for processing the textual data or the text data; a data field for storing the textual data or the text data; or a text field comprising a character string.

At 1004, the method 1000 includes accessing the text item.

At step 1006, the method 1000 includes rendering content of the text item.

In an embodiment, the method 1000 may further include processing or decoding the text item. In an embodiment, the processing or decoding the text item includes using a size of the text item as following: when a flag indicating an aspect ratio of the text item size is not set, and the item width and height are set to values different from 0, the size of the text item is the width and height as specified in the text item data structure; when a flag indicating an aspect ratio of the text item size is not set, and the item width and height are set to 0, the size of the text item matches the reference width and height (a reference size); or when a flag indicating an aspect ratio of the text item is set, it indicates that the content of the text item are authored to an aspect ratio equal to the ration of the width and height.

FIG. 11 illustrates an example method 1100 for defining a data structure, in accordance with an embodiment. As shown in block 806 of FIG. 8, the apparatus 800 includes means, such as the processing circuitry 802 or the like, to implement mechanisms for defining a text item or a renderable text. At 1102, the method 1100 includes defining a data structure. The data structure includes one or more of the following:
a reference width field for specifying a width of a reference space on which a renderable text data is placed;
a reference height field for specifying a height of the reference space on which the renderable text data is placed;
a language field comprising language tag string representing a language of the renderable text;
x and y fields for specifying a top, left corner of the renderable text relatively to the reference space, and wherein a value x=0 and y=0 represents a position of a top-left pixel in the reference space;
width and height fields for the renderable text describes a size of a rendering area in the reference area;
a flag for indicting at least one of a length of the fields x, y, the width, the height, the reference height, or the reference width for the renderable text;
a direction field for indicating a direction in which the content of the text item needs to be rendered; or
a text field comprising a character string comprising the renderable text; and
use the data structure to define the renderable text.

At 1102, the method 1100 includes using the data structure to define the renderable text or text item.

Referring to FIG. 12, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, for example, as part of a RU, but some examples of this may have the transceiver 160 as part of a separate RU, for example, under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, for example, link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (for example, a central unit (CU), gNB-CU) of the RAN node 170 to the RRH/DU 195. Reference 198 also indicates those suitable network link(s).

It is noted that description herein indicates that ‘cells’ perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (for example, the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, for example, an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of modules 140-1, 140-2, 150-1, and 150-2 may be configured for implementing mechanisms for carriage of renderable text. A computer program code 173 may also be configured for implementing mechanisms for carriage of renderable text.

As described above, FIGS. 9, 10, and 11 include a flowcharts of an apparatus (e.g. 50, 100, 604, 700, or 800), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 58, 125, 704, or 804) of an apparatus employing an embodiment of the present invention and executed by processing circuitry (e.g. 56, 120, 702, or 802) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 9, 10, and 11. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

1-54. (canceled)

55. An apparatus comprising at least one processor; and at least one memory comprising computer program code; wherein the at least one memory and the computer program code are configured to, with the at least one processor, cause the apparatus at least to perform:
defining a text item, wherein decoding of the text item results in a textual content or text data; and
associating the text item with a media item.

56. The apparatus of claim 55, wherein to define the text item, the apparatus is further to perform: defining at least one of a renderable item or a renderable item property, wherein the renderable item or the renderable item property comprises rendering information required to render a renderable text on a canvas, a background media item, or an overlay of the media item.

57. The apparatus of claim 56, wherein the rendering information comprises one or more of following parameters:
a language of the renderable text;
a location of the renderable text on the canvas or the background media item;
a width and a height of the renderable text; or
a direction of the renderable text.

58. The apparatus of claim 57, wherein the location is signaled by using a horizontal and a vertical offset from a top-left corner of the canvas or the background media.

59. The apparatus of claim 57, wherein the direction of the renderable text comprises left to right or right to left.

60. The apparatus of claim 56, wherein the apparatus is further caused to perform defining a mime type item for the renderable text, and wherein the media item comprising value of ‘mime’ in an item type comprises a mime type item.

61. The apparatus of claim 60, wherein data in the mime type item comprises the renderable text.

62. The apparatus of claim 56, wherein the renderable text is defined by using a text item data structure comprising one or more of the following:
a reference width field for specifying a width of a reference space on which the renderable text is placed;
a reference height field for specifying a height of the reference space on which the renderable text is placed;
a language field comprising language tag string representing a language of the renderable text;
x and y fields for specifying a top, left corner of the renderable text relatively to the reference space, and wherein a value x=0 and y=0 represents a position of a top-left pixel in the reference space;
width and height fields for the renderable text describes a size of a rendering area in a reference area;
a flag for indicting at least one of a length of the fields x, y, the width, the height, a reference height, or a reference width for the renderable text;
a direction field for indicating a direction in which content of the renderable text item needs to be rendered;
a text field comprising a character string comprising the renderable text; or
a font field for specifying fonts to be used for rendering or display of the renderable text.

63. The apparatus of claim 56, wherein the apparatus is further caused to perform: defining font item for specifying fonts used for the rendering of the renderable text.

64. The apparatus of claim 63, wherein when the fonts are not specified, the fonts are present at a rendering device or the fonts are signaled by using a supported font streaming mechanism.

65. The apparatus of claim 63, wherein the fonts are defined by using a name, a size, and/or a style.

66. An apparatus comprising at least one processor; and at least one memory comprising computer program code; wherein the at least one memory and the computer program code are configured to, with the at least one processor, cause the apparatus at least to perform:
receiving a bitstream comprising a media item, wherein the media item is associated with a text item;
accessing the text item; and
rendering content of the text item.

67. The apparatus of claim 66, wherein the text item comprises at least one of a renderable item or a renderable item property, wherein the renderable item or the renderable item property comprises rendering information required to render a renderable text on a canvas, a background media item, or an overlay of the media item.

68. The apparatus of claim 67, wherein the rendering information comprises one or more of following parameters:
a language of the renderable text;
a location of the renderable text on the canvas or the background media;
a width and a height of the renderable text; or
a direction of the renderable text.

69. The apparatus of claim 68, wherein the location is signaled by using a horizontal and a vertical offset from a top-left corner of the canvas or the background media.

70. The apparatus of claim 68, wherein the direction of the renderable text comprises left to right or right to left.

71. The apparatus of claim 67, wherein the renderable text is defined by using a text item data structure comprising one or more of the following:
a reference width field for specifying a width of a reference space on which the renderable text is placed;
a reference height field for specifying a height of the reference space on which the renderable text is placed;
a language field comprising language tag string representing a language of the renderable text;
x and y fields for specifying a top, left corner of the renderable text relatively to the reference space, and wherein a value x=0 and y=0 represents a position of a top-left pixel in the reference space;
width and height fields for the renderable text describes a size of a rendering area in a reference area;
a flag for indicting at least one of a length of the fields x, y, the width, the height, a reference height, or a reference width for the renderable text;
a direction field for indicating a direction in which the content of the text item needs to be rendered; or
a text field comprising a character string comprising the renderable text.

72. The apparatus of claim 67 further comprising defining font item for specifying fonts used for the rendering of the renderable text.

73. A method comprising:
defining a text item, wherein decoding of the text item results in a textual content or text data; and
associating the text item with a media item.

74. A method comprising:
receiving a bitstream comprising a media item, wherein the media item is associated with a text item;
accessing the text item; and
rendering content of the text item.
